(19) United States
(12) Patent Application Publication
(10) Pub. No.: US 2011/0194607 A1
(43) Pub. Date: Aug. 11, 2011

(54) Information Processing Device, Information Processing Method, and Program

(75) Inventors: Jun LUO, Tokyo (JP); Takefumi Nagumo, Kanagawa (JP); Yuhi Kondo, Tokyo (JP)

(73) Assignee: Sony Corporation, Tokyo (JP)

(21) Appl. No.: 12/980,946

(22) Filed: Dec. 29, 2010

(30) Foreign Application Priority Data
Feb. 5, 2010 (JP) 2010-024041

(51) Int. Cl. H04N 7/26

(52) U.S. Cl. 375/240.16; 375/E07.125

(57) ABSTRACT

An information processing device includes a bit conversion unit that performs reduction in a bit number allocated to a pixel for a criterion image and a reference image and generates a criterion image and a reference image which are hierarchized according to a bit number allocated to a pixel, and a motion vector detection unit that performs coarse detection of a motion vector by block matching using the criterion image and the reference image of which a bit number is reduced, decides a search range for fine detection of a motion vector based on the motion vector detected by the coarse detection, and performs fine detection of a motion vector using an image in the search range which belongs to a hierarchy equal to or more than an image used in the coarse detection in a bit number allocated to a pixel.

### BACKGROUND OF THE INVENTION

1. Field of the Invention

The present invention relates to an information processing device, an information processing method, and a program, and more particularly to an information processing device, an information processing method, and a program, capable of detecting a motion vector with high accuracy by a simple configuration.

2. Description of the Related Art

In the related art, a motion vector of an object in images differing in time is detected, and, based on the detected motion vector, noise reduction or the like is performed by, for example, a motion compensation interframe coding in high efficiency coding for images, or an interframe time domain filter.

Methods of detecting the motion vector include, for example, a block matching method which has been made use of. The block matching method divides one image plane into blocks including several pixels. Next, an evaluated value is calculated with pixel units by using a predetermined evaluation function, between the blocked image data and a search area obtained by image data of an image plane differing in time being divided into blocks so as to search for an area where the image data is moved. In addition, the calculated evaluated value is an optimal value which is the minimum, and thereby the motion vector is detected from a position of a block when the optimal value is obtained.

In such a block matching method, it is necessary to obtain a difference between a block to be detected and each block in a search range and a calculation amount in the detection of the motion vector increases. For this reason, in the invention disclosed in Japanese Unexamined Patent Application Publication No. 07-222158, a motion vector of pixel unit is detected in a higher rank hierarchy having a low resolution, and, based on the detected motion vector of pixel unit, a motion vector having accuracy equal to or less than the pixel unit is detected in the higher rank hierarchy. Also, based on the motion vector having equal to or less than the pixel unit, a motion vector is detected in a lower rank hierarchy having a resolution higher than the higher rank hierarchy, and thereby detection accuracy of a motion vector is improved and a calculation amount is reduced.

### SUMMARY OF THE INVENTION

Meanwhile, even when the motion vector is detected from a position of a block having, for example, the minimal sum of absolute difference SAD using an image with a lower resolution as in Japanese Unexamined Patent Application Publication No. 07-222158, a memory having a large capacity is used as a memory for storing images since a bit number allocated to a pixel is large and a motion vector is detected. Also, a circuit scale of a logic circuit calculating the evaluated value is large.

Therefore, it is desirable to provide an information processing device, an information processing method, and a program, capable of detecting a motion vector by a simple configuration with high accuracy.

According to an embodiment of the present invention, there is provided an information processing device includes a bit conversion unit that performs reduction in a bit number allocated to a pixel for a criterion image and a reference image and generates a criterion image and a reference image which are hierarchized according to a bit number allocated to a pixel; and a motion vector detection unit that performs a block matching process using a criterion image and a reference image and detects a motion vector from a block position in which a difference between blocks is minimal, wherein the motion vector detection unit performs coarse detection of a motion vector by block matching using the criterion image and the reference image of which a bit number is reduced, decides a search range for fine detection of a motion vector based on the motion vector detected by the coarse detection, and performs fine detection of a motion vector using an image in the search range which belongs to a hierarchy equal to or more than an image used in the coarse detection in a bit number allocated to a pixel.

In the embodiment of the present invention, the bit conversion unit performs reduction in a bit number allocated to a pixel for a criterion image and one or plural reference images and generates a criterion image and a reference image which are hierarchized according to a bit number allocated to a pixel. For example, 1-bit or the like criterion image and reference image are generated from 8-bit criterion image and reference image. The bit conversion unit performs filtering for the criterion image and the reference image using a mean filter or a band-pass filter, makes a comparison between pixel levels before and after the filtering for each pixel, and generates a criterion image and a reference image of which a bit number is reduced based on a result of the comparison. The motion vector detection unit performs a block matching process using a criterion image and a reference image and detects a motion vector from a block position in which a difference between blocks is minimal. In addition, in the motion vector detection, coarse detection of a motion vector is performed by block matching using the criterion image and the reference image of which a bit number is reduced. For example, the coarse detection of a motion vector is performed using 1-bit criterion image and reference image of which a bit number allocated to a pixel is smallest. A search range for fine detection of a motion vector is decided based on the motion vector detected by the coarse detection, and fine detection of a motion vector is performed using an image in the search range which belongs to a hierarchy equal to or more than an image used in the coarse detection, that is, using an image of which a bit number allocated to a pixel is 1 bit or more. Also, there is further provided a resolution conversion unit that performs downsampling for the criterion image and the reference image to reduce resolutions of the criterion image and the reference image, and coarse detection of a motion vector is performed using the criterion image and the reference image of which a resolution is reduced, and fine detection of a motion vector is performed using an image in a fine search range equal to or more than an image used in the coarse detection in a resolution.

According to an embodiment of the present invention, there is provided an information processing method including the steps of causing a bit conversion unit to perform reduction in a bit number allocated to a pixel for a criterion image and a reference image and generate a criterion image and a reference image which are hierarchized according to a bit number allocated to a pixel; and causing a motion vector detection unit to perform coarse detection of a motion vector by block matching using the criterion image and the reference image of which a bit number is reduced, decide a search range for fine detection of a motion vector based on the motion vector detected by the coarse detection, and perform fine detection of a motion vector using an image in the search range which belongs to a hierarchy equal to or more than an image used in the coarse detection in a bit number allocated to a pixel.

According to an embodiment of the present invention, there is provided a program enabling a computer to perform the steps of performing reduction in a bit number allocated to a pixel for a criterion image and a reference image and generating a criterion image and a reference image which are hierarchized according to a bit number allocated to a pixel; and performing coarse detection of a motion vector by block matching using the criterion image and the reference image of which a bit number is reduced, deciding a search range for fine detection of a motion vector based on the motion vector detected by the coarse detection, and performing fine detection of a motion vector using an image in the search range which belongs to a hierarchy equal to or more than an image used in the coarse detection in a bit number allocated to a pixel.

The program according to the embodiment of the present invention is a program which can be provided via a storage medium which is provided in a computer readable format to a general computer and a system capable of executing, for example, various programs and codes, for example, such as an optical disc, a magnetic disk, or a semiconductor memory, or via a communication medium such as a network. Such a program is provided in a computer readable format, and thereby processes according to the program are realized on the computer and the system.

According to the embodiment of the present invention, the bit conversion unit performs reduction in a bit number allocated to a pixel for a criterion image and reference images and generates a criterion image and a reference image which are hierarchized according to a bit number allocated to a pixel. In addition, the motion vector detection unit performs coarse detection of a motion vector by block matching using the criterion image and the reference image of which a bit number allocated to a pixel is reduced, decides a search range for fine detection of a motion vector based on the motion vector detected by the coarse detection, and performs fine detection of a motion vector using an image in the search range which belongs to a hierarchy equal to or more than an image used in the coarse detection in a bit number allocated to a pixel. In this way, since the coarse detection of a motion vector is performed using an image having a small bit number, it is possible to perform the coarse detection of a motion vector without using a large capacity of a memory or a logic circuit having a large circuit scale. Further, since a search range for fine detection of a motion vector is decided based on the motion vector detected by the coarse detection, and fine detection of a motion vector is performed using an image in the search range which belongs to a hierarchy equal to or more than an image used in the coarse detection in a bit number allocated to a pixel, it is possible to detect a motion vector with high accuracy even if a wide range is not searched. In other words, it is possible to detect a motion vector with high accuracy by a simple configuration without using a large capacity of a memory or a logic circuit having a large circuit scale.

### BRIEF DESCRIPTION OF THE DRAWINGS

FIG. 1 is a diagram illustrating a configuration of an information processing device according to a first embodiment.

FIG. 2 is a flowchart illustrating a process in the information processing device according to the first embodiment.

FIG. 3 is a diagram illustrating a configuration of a low bit criterion image generation unit which generates a 1-bit image.

FIG. 4 is a flowchart illustrating a process in the low bit criterion image generation unit which generates a 1-bit image.

FIG. 5 is a diagram illustrating a configuration of the low bit criterion image generation unit which generates a 2-bit image.

FIG. 6 is a flowchart illustrating a process in the low bit criterion image generation unit which generates a 2-bit image.

FIG. 7 is a diagram illustrating a configuration of the low bit criterion image generation unit which generates an n-bit image.

FIG. 8 is a flowchart illustrating a process in the low bit criterion image generation unit which generates an n-bit image.

FIG. 9 is a diagram illustrating the relationship between a comparison result and a pixel value.

FIG. 10 is a diagram illustrating a configuration of a low bit reduced criterion image generation unit which generates a 1-bit image.

FIGS. 11A to 11C are diagrams exemplarily illustrating a generation operation of reduced images.

FIG. 12 is a flowchart illustrating a process in the low bit reduced criterion image generation unit which generates a 1-bit image.

FIG. 13 is a diagram illustrating a configuration of a block matching unit.

FIG. 14 is a flowchart illustrating a process in the block matching unit.

FIG. 15 is a flowchart illustrating an XOR value calculation process.

FIG. 16 is a diagram exemplarily illustrating a detection operation of a motion vector.

FIG. 17 is a diagram illustrating a motion vector detected by coarse detection and a motion vector detected by fine detection.

FIG. 18 is a diagram illustrating a configuration of an information processing device according to a second embodiment.

FIG. 19 is a flowchart illustrating a process in the information processing device according to the second embodiment.

FIG. 20 is a diagram illustrating a configuration of an optimal motion vector selection unit.

FIG. 21 is a flowchart illustrating a process in the optimal motion vector selection unit.

FIG. 22 is a diagram exemplarily illustrating a detection operation of a motion vector using a criterion image and two reference images.

FIGS. 23A and 23B are diagrams illustrating a hierarchy of an image.

FIG. 24 is a diagram illustrating a configuration example of computer hardware.

### DESCRIPTION OF THE PREFERRED EMBODIMENTS

Hereinafter, embodiments of the present invention will be described. The description will be made in the following order.

1. First embodiment

1-1. Configuration of information processing device

1-2. Processing operation of information processing device

1-3. Configuration and operation of low bit image generation unit

1-4. Configuration and operation of low bit reduced image generation unit

1-5. Configuration and operation of block matching unit

1-6. Example of detection operation of a motion vector using two images

2. Second embodiment

2-1. Configuration of information processing device

2-2. Processing operation of information processing device

2-3. Configuration and operation of optimal motion vector selection unit

2-4. Example of detection operation of a motion vector using three images

3. As to the case where process is performed using program

### 1. First Embodiment

An information processing device according to an embodiment of the present invention performs a bit number reduction process where a bit number allocated to a pixel is reduced for a criterion image and a reference image, and generates a criterion image and a reference image which are hierarchized according to a bit number allocated to the pixel. Next, the information processing device performs coarse detection of a motion vector through block matching using the criterion image and reference image of which the bit number is reduced. In addition, the information processing device decides a search range for fine detection of a motion vector based on the motion vector detected by the coarse detection of a motion vector, and performs fine detection of a motion vector using an image in the search range which belongs to a hierarchy equal to or more than an image used in the coarse detection in a bit number allocated to a pixel.

In addition to the bit number reduction process, the information processing device may perform a pixel number reduction process for a criterion image and a reference image so as to decrease resolutions of the criterion image and the reference image. In this case, the information processing device performs coarse detection of a motion vector through block matching using, for example, the criterion image and reference image of which a resolution is reduced, and, based on the detected motion vector, decides a search range for fine detection of a motion vector. In addition, the information processing device performs the fine detection of a motion vector using an image in a fine search range equal to or more than an image used in the coarse detection in the resolution.

Also, in the following description, a case is shown in which a motion vector is detected using a criterion image and a reference image of two hierarchies of which a bit number allocated to a pixel is different. Further, in the following description, a case is shown in which the pixel number reduction process is performed only for a criterion image and a reference image used in coarse detection of a motion vector.

### 1-1. Configuration of Information Processing Device

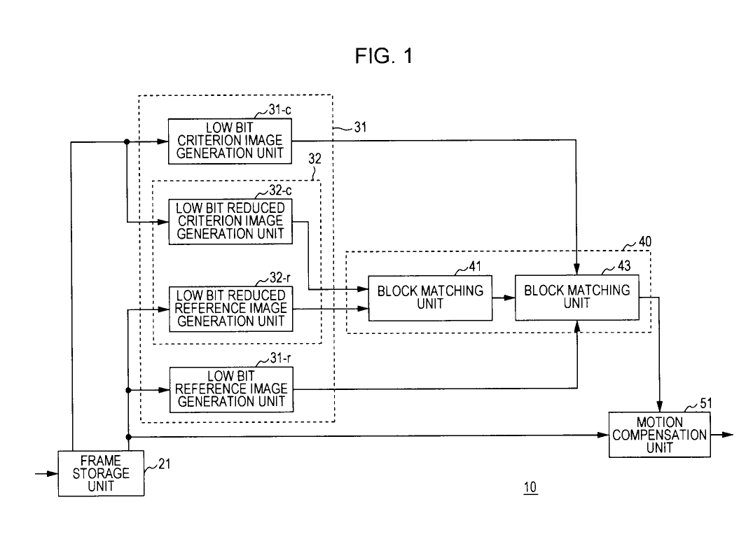

FIG. 1 shows a configuration of an information processing device according to the first embodiment. The information processing device 10 includes an image storage unit 21 which stores input image data. Also, the information processing device 10 includes a bit conversion unit 31 which reduces a bit number allocated to a pixel and which has a low bit criterion image generation unit 31-c, a low bit reference image generation unit 31-r, a low bit reduced criterion image generation unit 32-c, and a low bit reduced reference image generation unit 32-r. The low bit reduced criterion image generation unit 32-c and the low bit reduced reference image generation unit 32-r constitute a resolution conversion unit 32 which generates a reduced image of which a resolution is lowered due to the pixel number reduction process. Further, the information processing device 10 has a motion vector detection unit 40 which detects a motion vector and which has block matching units 41 and 43. Further, the information processing device 10 has a motion compensation unit 51 which performs motion compensation using the detected motion vector.

The image storage unit 21 stores image data of a criterion image and a reference image. The image storage unit 21 outputs the stored image data of the criterion image to the low bit criterion image generation unit 31-c and the low bit reduced criterion image generation unit 32-c. The image storage unit 21 outputs the stored image data of the reference image to the low bit reference image generation unit 31-r and the low bit reduced reference image generation unit 32-r.

The low bit criterion image generation unit 31-c performs a bit number reduction process for the image data of the criterion image to generate image data of a low bit criterion image. Also, the low bit criterion image generation unit 31-c outputs the generated image data of the low bit criterion image to the block matching unit 43. For example, the low bit criterion image generation unit 31-c performs the bit number reduction process for 8-bit image data of a criterion image and outputs image data of a low bit criterion image of which a bit number is 1 bit, to the block matching unit 43.

The low bit reduced criterion image generation unit 32-c performs the bit number reduction process for the image data of the criterion image. Also, the low bit reduced criterion image generation unit 32-c performs the pixel number reduction process for the criterion image of which the bit number is reduced, and generates a low bit reduced criterion image. The low bit reduced criterion image generation unit 32-c outputs image data of the generated low bit reduced criterion image to the block matching unit 41. For example, the low bit reduced criterion image generation unit 32-c performs the bit number reduction process and the pixel number reduction process for 8-bit image data of a criterion image and outputs image data of a low bit reduced criterion image of which the bit number is 1 bit and the pixel number is reduced in horizontal and vertical directions to the block matching unit 41.

The low bit reference image generation unit 31-r performs the bit number reduction process for the image data of the reference image to generate a low bit reference image having the same bit number as the low bit criterion image. Also, the low bit reference image generation unit 31-r outputs image data of the generated low bit reference image to the block matching unit 43.

The low bit reduced reference image generation unit 32-r performs the bit number reduction process and the pixel number reduction process for the image data of the reference image to generate a low bit reduced reference image having the same bit number and pixel number as the low bit reduced reference image. Also, the low bit reduced reference image generation unit 32-r outputs image data of the generated low bit reduced reference image to the block matching unit 41.

The block matching unit 41 performs coarse detection of a motion vector using the image data of the low bit reduced criterion image output from the low bit reduced criterion image generation unit 32-c and the image data of the low bit reduced reference image output from the low bit reduced reference image generation unit 32-r. The block matching unit 41 detects a block for which an evaluated value calculated by a block matching process is minimal, and detects a motion vector from positions of two blocks. In addition, the block matching unit 41 outputs the detected motion vector to the block matching unit 43.

The block matching unit 43 performs fine detection of a motion vector using the image data of the low bit criterion image output from the low bit criterion image generation unit 31-c and the image data of the low bit reference image output from the low bit reference image generation unit 31-r. The block matching unit 43 has been supplied with the motion vector detected by the coarse detection of a motion vector in the block matching unit 41. Therefore, the block matching unit 43 decides a search range for the block matching process based on the motion vector supplied from the block matching unit 41. The block matching unit 43 performs the block matching process in the decided search range, detects a block having a minimal evaluated value, and detects a motion vector from positions of two blocks.

The information processing device 10 includes the motion compensation unit 51, and this motion compensation unit 51 performs motion compensation for the reference image using the motion vector detected by the block matching unit 43 and outputs the motion compensated image.

### 1-2. Processing Operation of Information Processing Device

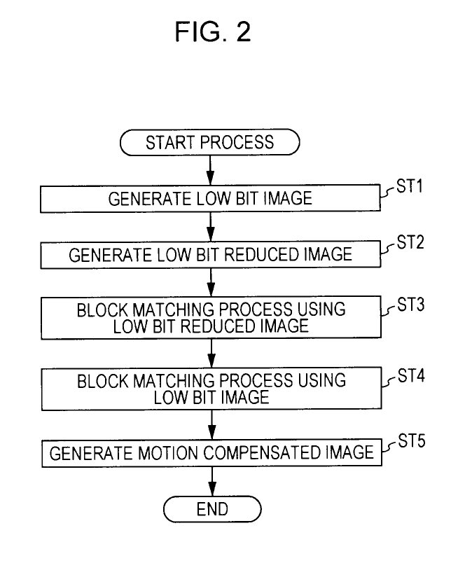

FIG. 2 is a flowchart illustrating a process in the information processing device 10. At step ST1, the low bit criterion image generation unit 31-c and the low bit reference image generation unit 31-r generate low bit images. The low bit criterion image generation unit 31-c performs the bit number reduction process for image data of a criterion image to generate image data of a low bit criterion image. The low bit reference image generation unit 31-r performs the bit number reduction process for image data of a reference image to generate image data of a low bit reference image. In this way, the low bit criterion image generation unit 31-c and the low bit reference image generation unit 31-r generate the low bit images, and the process goes to step ST2.

At step ST2, the low bit reduced criterion image generation unit 32-c and the low bit reduced reference image generation unit 32-r generate low bit reduced images. The low bit reduced criterion image generation unit 32-c performs the bit number reduction process and the pixel number reduction process for image data of a criterion image to generate image data of a low bit reduced criterion image. The low bit reduced reference image generation unit 32-r performs the bit number reduction process and the pixel number reduction process for image data of a reference image to generate image data of a low bit reduced reference image. In this way, the low bit reduced criterion image generation unit 32-c and the low bit reduced reference image generation unit 32-r generate the low bit reduced images, and the process goes to step ST3.

At step ST3, the block matching unit 41 performs the block matching process using the low bit reduced images. The block matching unit 41 performs the block matching process for the image data of the low bit reduced criterion image and the image data of the low bit reduced reference image and detects a motion vector. In this way, the block matching unit 41 performs coarse detection of a motion vector through the block matching process using the low bit reduced images, and the process goes to step ST4.

At step ST4, the block matching unit 43 performs the block matching process using the low bit images. The block matching unit 43 decides a search range based on the motion vector detected by the coarse detection of a motion vector at step ST3. Also, the block matching unit 43 performs the block matching process using the low bit criterion image, and the low bit reference image in the search range, and detects a motion vector. In this way, the block matching unit 43 performs fine detection of a motion vector through the block matching process using the low bit images, and the process goes to step ST5.

At step ST5, the motion compensation unit 51 generates a motion compensated image. The motion compensation unit 51 performs motion compensation for the reference image according to the motion vector detected at step ST4 to generate a motion compensated image, and the process is finished.

### 1-3. Configuration and Operation of Low Bit Image Generation Unit

Next, generation of low bit images will be described. The low bit image generation unit performs filtering for a criterion image, compares image data before the filtering with image data after the filtering every pixel, and generates a criterion image of which a bit number is reduced based on the comparison result. Likewise, the low bit image generation unit performs filtering for a reference image, compares image data before the filtering and image data after the filtering every pixel, and generates a reference image of which a bit number is reduced based on the comparison result.

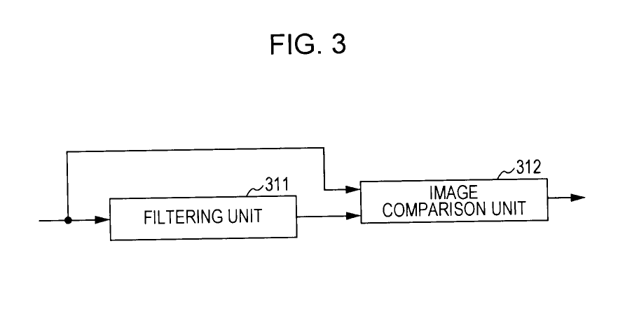

FIG. 3 shows a configuration of the low bit criterion image generation unit 31-c which generates a 1-bit image. Also, the low bit reference image generation unit 31-r is configured in the same manner as the low bit criterion image generation unit 31-c, and the low bit reference image generation unit 31-r performs the same process for a reference image as the low bit criterion image generation unit 31-c.

The low bit criterion image generation unit 31-c has a filtering unit 311 and an image comparison unit 312. The filtering unit 311 performs filtering for image data of a criterion image. The filtering unit 311 performs the filtering for the image data of the criterion image using one of, for example, a mean filter, a band-pass filter, and a pseudo mean filter.

The filtering unit 311 performs calculation in Equation 1 in a case of using the mean filter, and calculates pixel data I′(x, y) after filtering a pixel position (x, y). Here, I(i, j) indicates pixel data of a criterion image, and N indicates the number of pixels.

$${I}^{′} ( x , y ) = \frac{1}{{N}^{2}} {\sum }_{i = x - \frac{N}{2}}^{x + \frac{N}{2}} {\sum }_{j = y - \frac{N}{2}}^{y + \frac{N}{2}} I ( i , j ) \qquad ( 1 )$$

The filtering unit 311 performs calculation in Equation 2 in a case of using the band-pass filter, and calculates pixel data I′(x, y) after filtering a pixel position (x, y). Here, in Equation 2, “K” indicates a coefficient for deciding filter characteristics and is, for example, a value shown in Equation 3.

$$\begin{matrix}{I}^{′} ( x , y ) = {\sum }_{i = x - \frac{N}{2}}^{x + \frac{N}{2}} {\sum }_{j = y - \frac{N}{2}}^{y + \frac{N}{2}} ( I ( i , j ) \times K ( i + \frac{N}{2} , j + \frac{N}{2} ) ) & ( 2 ) \\ K = \frac{1}{16} [ \begin{matrix}0 & 0 & 0 & 0 & 0 & 0 & 0 & 0 & 0 & 1 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 1 & 0 & 0 & 0 & 0 & 0 & 1 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 1 & 0 & 0 & 0 & 0 & 0 & 1 & 0 & 0 & 0 & 0 & 0 & 1 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 1 & 0 & 0 & 0 & 0 & 0 & 1 & 0 & 0 & 0 & 0 & 0 & 1 & 0 & 0 & 0 & 0 & 0 & 1 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 1 & 0 & 0 & 0 & 0 & 0 & 1 & 0 & 0 & 0 & 0 & 0 & 1 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 1 & 0 & 0 & 0 & 0 & 0 & 1 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 1 & 0 & 0 & 0 & 0 & 0 & 0 & 0 & 0 & 0\end{matrix} ] & ( 3 )\end{matrix}$$

The filtering unit 311 performs calculation in Equation 4 in a case of using the pseudo mean filter, and calculates pixel data I′(x, y) after filtering a pixel position (x, y).

$${I}^{′} ( x , y ) = \frac{1}{2} ( {max}_{( i , j ) ∈ ( N \times N )} ( I ( i , j ) ) + {min}_{( i , j ) ∈ ( N \times N )} ( I ( i , j ) ) ) \qquad ( 4 )$$

The image comparison unit 312 compares the image data of the criterion image with the image data after the filtering, and designates a 1-bit signal indicating the comparison result as image data of a low bit criterion image.

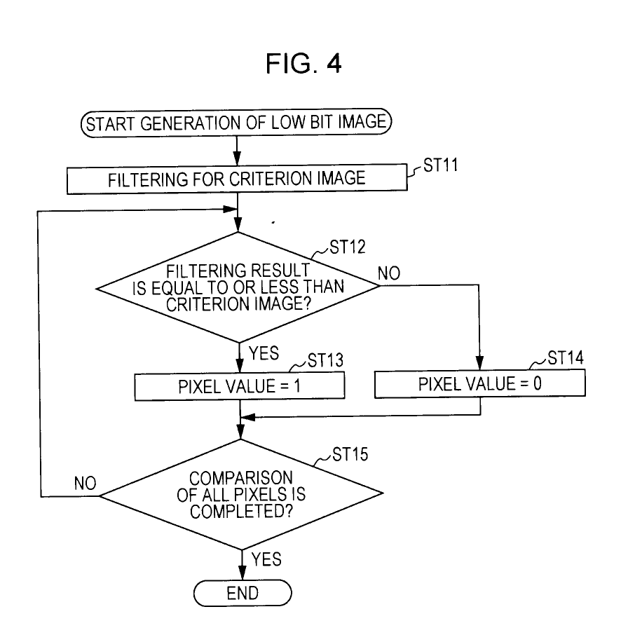

FIG. 4 is a flowchart illustrating a process in the low bit criterion image generation unit 31-c which generates a 1-bit image. At step ST11, the low bit criterion image generation unit 31-c performs filtering for a criterion image. The low bit criterion image generation unit 31-c performs filtering using a filter such as the means filter or the band-pass filter for the image data of the criterion image, and the process goes to step ST12.

At step ST12, the low bit criterion image generation unit 31-c determines whether or not the filtering result is equal to or less than the criterion image. The low bit criterion image generation unit 31-c makes a comparison between pieces of pixel data in the respective image positions, using the image data after the filtering and the image data of the criterion image. When the pixel data as a result of the filtering is equal to or less than the pixel data of the criterion image, the low bit criterion image generation unit 31-c performs a process at step ST13. On the other hand, when the pixel data as a result of the filtering is greater than the pixel data of the criterion image, the low bit criterion image generation unit 31-c performs a process at step ST14.

The low bit criterion image generation unit 31-c sets a pixel value to “1” at step ST13, and the process goes to step ST15.

The low bit criterion image generation unit 31-c sets a pixel value to “0” at step ST14, and the process goes to step ST15.

At step ST15, the low bit criterion image generation unit 31-c determines whether or not comparison of all pixels is completed. When comparison of all pixels is not completed, the process returns to step ST12, and the low bit criterion image generation unit 31-c compares subsequent pixels. When comparison of all pixels is completed, the low bit criterion image generation unit 31-c finishes the process.

In this way, the image data before the filtering and the image data after the filtering are compared every pixel, and an image where the bit number allocated to a pixel is 1 bit can be generated based on the comparison result.

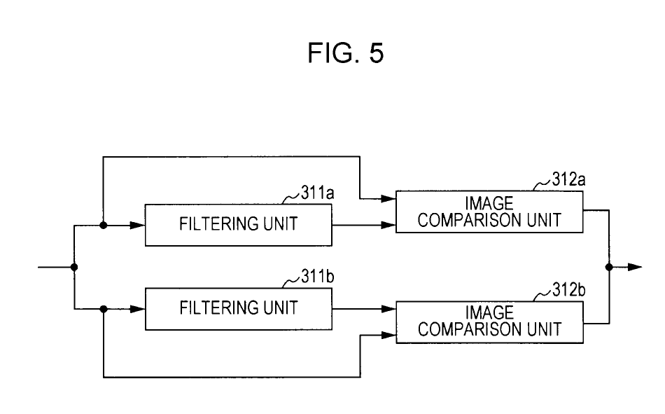

Next, a case where the low bit criterion image generation unit 31-c generates 2-bit images or n-bit images will be described. FIG. 5 shows a configuration of the low bit criterion image generation unit 31-c which generates a 2-bit image.

The low bit criterion image generation unit 31-c includes filtering units 311a and 311b and image comparison units 312a and 312b. The filtering unit 311a performs filtering for image data of a criterion image. The filtering unit 311a performs filtering using a filter such as the means filter, the band-pass filter or the pseudo mean filter as described above, for the image data of the criterion image. The image comparison unit 312a compares the image data of the criterion image with the image data after the filtering, and designates a 1-bit signal indicating the comparison result as least significant bit data of a 2-bit image. The filtering unit 311b performs filtering for the image data of the criterion image, using filter characteristics different from the filtering unit 311a. The filtering unit 311b performs filtering using a filter such as the means filter, the band-pass filter or the pseudo mean filter as described above, for the image data of the criterion image, in the same manner as filtering unit 311a. The image comparison unit 312b compares the image data of the criterion image with the image data after the filtering, and designates a 1-bit signal indicating the comparison result as most significant bit data of a 2-bit image.

In this way, the image data before the filtering and the image data after the filtering are compared every pixel, and an image where a bit number allocated to a pixel is 2 bits can be generated based on the comparison result.

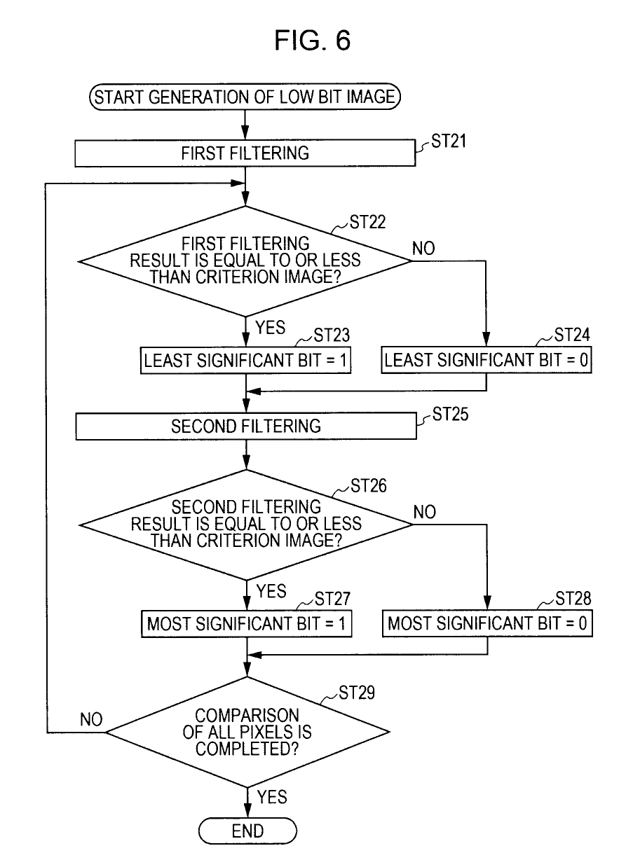

FIG. 6 is a flowchart illustrating a process in the low bit criterion image generation unit 31-c which generates a 2-bit image. At step ST21, the low bit criterion image generation unit 31-c performs first filtering for a criterion image. The low bit criterion image generation unit 31-c performs the first filtering for image data of the criterion image, using a filter such as the mean filter or the band-pass filter, and the process goes to step ST22.

At step ST22, the low bit criterion image generation unit 31-c determines whether or not the first filtering result is equal to or less than the criterion image. The low bit criterion image generation unit 31-c makes a comparison between pieces of pixel data in the respective pixel positions using the image data after the filtering and the image data of the criterion image. When the pixel data as a result of the filtering is equal to or less than the pixel data of the criterion image, the low bit criterion image generation unit 31-c performs a process at step ST23. On the other hand, when the pixel data as a result of the filtering is greater than the pixel data of the criterion image, the low bit criterion image generation unit 31-c performs a process at step ST24.

At step ST23, the low bit criterion image generation unit 31-c sets a pixel value to “1” so as to be designated as least significant bit data of a 2-bit image, and the process goes to step ST25.

At step ST24, the low bit criterion image generation unit 31-c sets a pixel value to “0” so as to be designated as least significant bit data of a 2-bit image, and the process goes to step ST25.

At step ST25, the low bit criterion image generation unit 31-c performs second filtering for the criterion image. The low bit criterion image generation unit 31-c performs the second filtering for the image data of the criterion image using a filter such as the mean filter or the band-pass filter having characteristics different from step ST21, and the process goes to step ST26.

At step ST26, the low bit criterion image generation unit 31-c determines whether or not the second filtering result is equal to or less than the criterion image. The low bit criterion image generation unit 31-c makes a comparison between pieces of pixel data in the respective pixel positions using the image data after the filtering and the image data of the criterion image. When the pixel data as a result of the filtering is equal to or less than the pixel data of the criterion image, the low bit criterion image generation unit 31-c performs a process at step ST27. On the other hand, when the pixel data as a result of the filtering is greater than the pixel data of the criterion image, the low bit criterion image generation unit 31-c performs a process at step ST28.

At step ST27, the low bit criterion image generation unit 31-c sets a pixel value to “1” so as to be designated as most significant bit data of a 2-bit image, and the process goes to step ST29.

At step ST28, the low bit criterion image generation unit 31-c sets a pixel value “0” so as to be designated as most significant bit data of a 2-bit image, and the process goes to step ST29.

At step ST29, the low bit criterion image generation unit 31-c determines whether or not comparison of all pixels is completed. When comparison of all pixels is not completed, the process returns to step ST22, and the low bit criterion image generation unit 31-c compares subsequent pixels. When comparison of all pixels is completed, the low bit criterion image generation unit 31-c finishes the process.

In this way, the image data before the filtering and the image data after the filtering are compared every pixel, and an image where the bit number allocated to a pixel is 2 bits can be generated based on the comparison result.

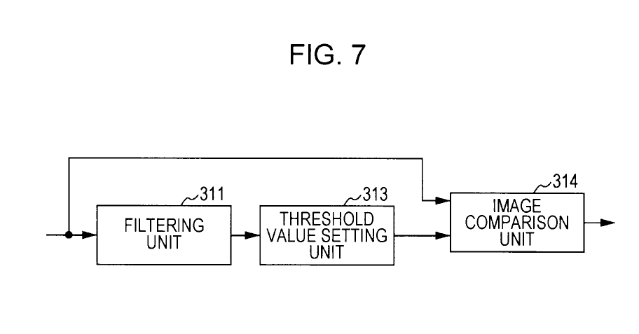

Next, a case where n-bit images are generated will be described. FIG. 7 shows a configuration of the low bit criterion image generation unit 31-c which generates an n-bit image.

The low bit criterion image generation unit 31-c includes a filtering unit 311, a threshold value setting unit 313, and an image comparison unit 314. The filtering unit 311 performs a filtering for image data of a criterion image. The filtering unit 311 performs the filtering for the image data of the criterion image using a filter such as the mean filter, the band-pass filter, or the pseudo mean filter as described above.

The threshold value setting unit 313 performs a shift process for the image data after the filtering, and sets the image data after the filtering or the image data after the shift process as a threshold value. Also, the threshold value setting unit 313 outputs the set threshold value to the image comparison unit 314.

The image comparison unit 314 compares the image data of the criterion image with the threshold value output from the threshold value setting unit 313 for each pixel, and designates an n-bit signal indicating the comparison result as image data of a low bit criterion image.

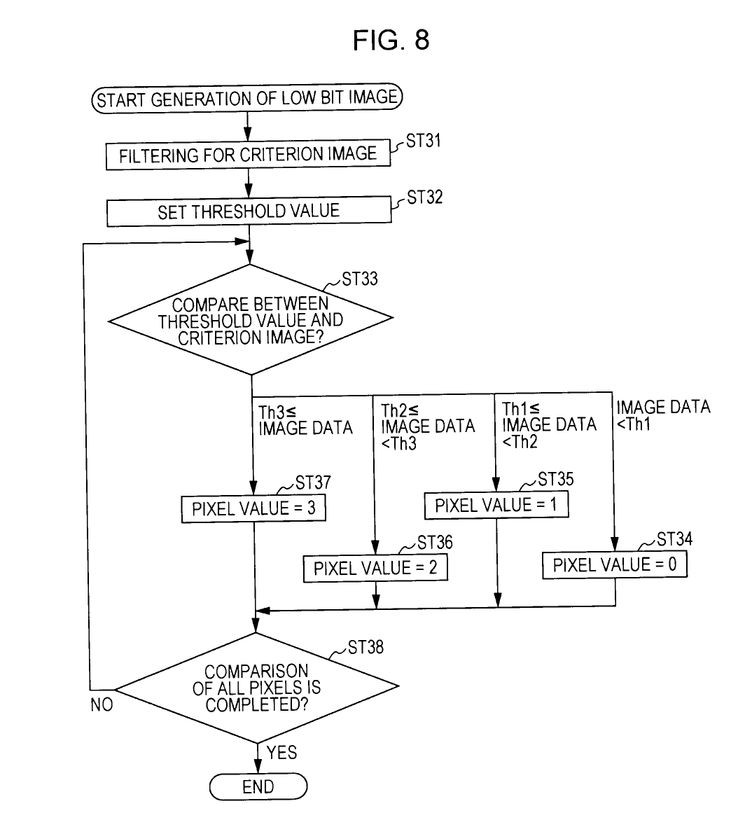

FIG. 8 is a flowchart illustrating a process in the low bit criterion image generation unit 31-c which generates an n-bit image. At step ST31, the low bit criterion image generation unit 31-c performs filtering for a criterion image. The low bit criterion image generation unit 31-c performs filtering using a filter such as the means filter or the band-pass filter for the image data of the criterion image, and the process goes to step ST32.

At step ST32, the low bit criterion image generation unit 31-c sets a threshold value. The low bit criterion image generation unit 31-c performs the shift process for the image data after the filtering, and sets the image data after the filtering or the image data after the shift process as a threshold value, and the process goes to step ST33. For example, when generating a 2-bit image, the low bit criterion image generation unit 31-c designates image data which is reduced from the image data after the filtering by a shift amount set in advance, as a first threshold value. Also, the low bit criterion image generation unit 31-c designates the image data after the filtering as a second threshold value, and designates image data which is increased from the image data after the filtering by a shift amount set in advance as a third threshold value. Further, when generating an n-bit image, the low bit criterion image generation unit 31-c sets (2ⁿ−1) threshold values based on the image data after the filtering.

At step ST33, the low bit criterion image generation unit 31-c compares the image data of the criterion image with the threshold value for each pixel. When the image data of the criterion image is smaller than the first threshold value Th1, the low bit criterion image generation unit 31-c performs a process at step ST34. When the image data of the criterion image is equal to or more than the first threshold value Th1 and smaller than the second threshold value Th2, the low bit criterion image generation unit 31-c performs a process at step ST35. When the image data of the criterion image is equal to or more than the second threshold value Th2 and smaller than the third threshold value Th3, the low bit criterion image generation unit 31-c performs a process at step ST36. When the image data of the criterion image is equal to or more than the third threshold value Th3, the low bit criterion image generation unit 31-c performs a process at step ST37.

The low bit criterion image generation unit 31-c sets a pixel value to “0” at step ST34, and the process goes to step ST38.

The low bit criterion image generation unit 31-c sets a pixel value to “1” at step ST35, and the process goes to step ST38.

The low bit criterion image generation unit 31-c sets a pixel value to “2” at step ST36, and the process goes to step ST38.

The low bit criterion image generation unit 31-c sets a pixel value to “3” at step ST37, and the process goes to step ST38.

At step ST38, the low bit criterion image generation unit 31-c determines whether or not comparison of all pixels is completed. When comparison of all pixels is not completed, the process returns to step ST32, and the low bit criterion image generation unit 31-c compares subsequent pixels. When comparison of all pixels is completed, the low bit criterion image generation unit 31-c finishes the process.

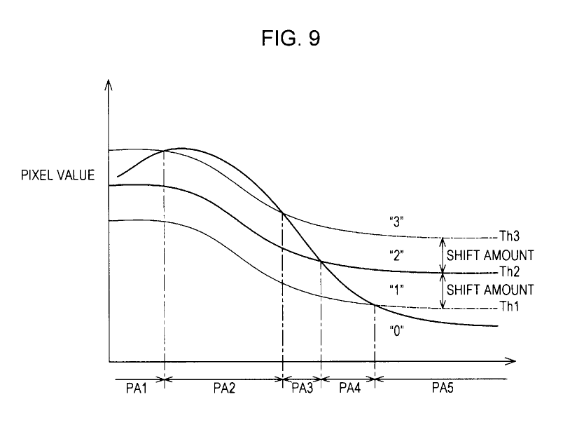

FIG. 9 shows an example of relationships between the comparison results and the pixel values. When a pixel is positioned in a region PA1, the pixel value of the criterion image is equal to or more than the second threshold value Th2 and smaller than the third threshold value Th3. Therefore, the low bit criterion image generation unit 31-c designates the pixel vale in the region PA1 as “2.” When a pixel is positioned in a region PA2, the pixel value of the criterion image is equal to or more than the third threshold value Th3. Therefore, the low bit criterion image generation unit 31-c designates the pixel value in the region PA2 as “3.” When a pixel is positioned in a region PA3, the pixel value of the criterion image is equal to or more than the second threshold value Th2 and smaller than the third threshold value Th3. Therefore, the low bit criterion image generation unit 31-c designates the pixel value in the PA3 as “2.” When a pixel is positioned in a region PA4, the pixel value of the criterion image is equal to or more than the first threshold value Th1 and smaller than the second threshold value Th2. Therefore, the low bit criterion image generation unit 31-c designates the pixel value in the PA4 as “1.” When a pixel is positioned in a region PA5, the pixel value of the criterion image is smaller than the first threshold value Th1. Therefore, the low bit criterion image generation unit 31-c designates the pixel value in the PA5 as “0.”

In this way, by changing to the image data after the filtering and using the threshold values set based on the image data after the filtering, the threshold value and pixel levels before the filtering are compared every pixel, and an image where the bit number allocated to a pixel is n bits can be generated based on the comparison result.

### 1-4. Configuration and Operation of Low Bit Reduced Image Generation Unit

Next, generation of a low bit reduced image will be described. The low bit reduced image generation unit performs the pixel number reduction process by generating one pixel representing plural pixels among the adjacent plural pixels or by subsampling pixels, and generates a reduced image. Also, the low bit reduced image generation unit performs filtering for image data of the reduced image, and designates data indicating a comparison result between image data before the filtering and image data after the filtering for each pixel, as image data having undergone the pixel number reduction process and the bit number reduction process.

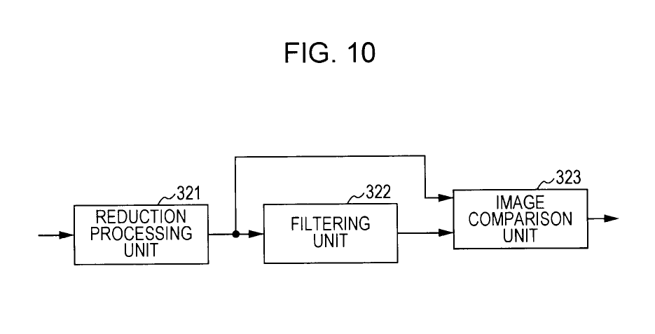

FIG. 10 shows a configuration of the low bit reduced criterion image generation unit 32-c which generates a 1-bit image. The low bit reduced reference image generation unit 32-r is configured in the same manner as the low bit reduced criterion image generation unit 32-c, and the low bit reduced reference image generation unit 32-r performs the same process for a reference image as the low bit reduced criterion image generation unit 32-c.

The low bit reduced criterion image generation unit 32-c has a reduction processing unit 321, a filtering unit 322, and an image comparison unit 323. The reduction processing unit 321 generates a reduced image.

The reduction processing unit 321 uses adjacent plural pixels as reduction processing unit, generates one pixel from the plural pixels in the reduction processing unit, and thereby reduces the number of pixels and generates a reduced image.

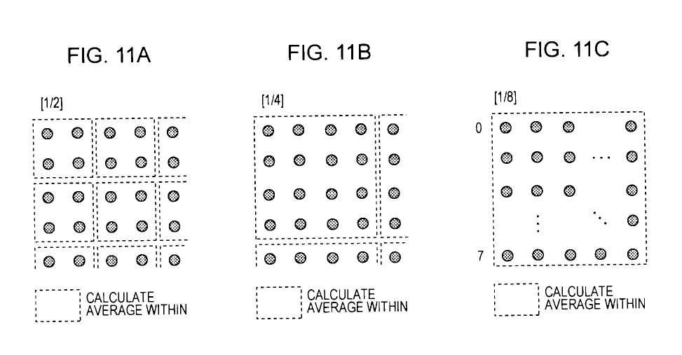

FIGS. 11A to 11C show examples of generation operations of reduced images. FIG. 11A shows reduction processing unit when an image is reduced to ½ times. Also, FIG. 11B shows reduction processing unit when an image is reduced to ¼ times, and FIG. 11C shows reduction processing unit when an image is reduced to ⅛ times. The reduction processing unit 321 uses adjacent 2×2 pixels as the reduction processing unit when reducing an image to ½ times. Also, the reduction processing unit 321 uses adjacent 4×4 pixels as the reduction processing unit when reducing an image to ¼ times, and uses adjacent 8×8 pixels as the reduction processing unit when reducing an image to ⅛ times. Further, the reduction processing unit 321 calculates image data having one pixel as the reduction processing unit, from plural pieces of pixel data included in the reduction processing unit. For example, the reduction processing unit 321 calculates a mean value of plural pieces of pixel data included in the reduction processing unit, which is designated as pixel data when the reduction processing unit includes one pixel. In this way, the reduction processing unit 321 generates one pixel from the plural pixels included in the reduction processing unit. Thus, when the reduction processing unit is set as shown in FIG. 11A, the reduction processing unit 321 generates a reduced image of which the number of pixels in horizontal and vertical directions is reduced to ½ times. When the reduction processing unit is set as shown in FIG. 11B, the reduction processing unit 321 generates a reduced image of which the number of pixels in horizontal and vertical directions is reduced to ¼ times. When the reduction processing unit is set as shown in FIG. 11C, the reduction processing unit 321 generates a reduced image of which the number of pixels in horizontal and vertical directions is reduced to ⅛ times.

The process by the reduction processing unit 321 is not limited to the process shown in FIGS. 11A to 11C. The reduction processing unit 321 may generate a reduced image by, for example, pixel subsampling or the like.

The filtering unit 322 performs filtering for the image data of the criterion image. The filtering unit 322 performs the filtering for the image data of the criterion image using a filter such as, for example, the mean filter, the band-pass filter, or the pseudo mean filter.

The image comparison unit 323 compares the image data of the criterion image with the image data after the filtering, and designates a 1-bit signal indicating the comparison result as image data of a low bit criterion image.

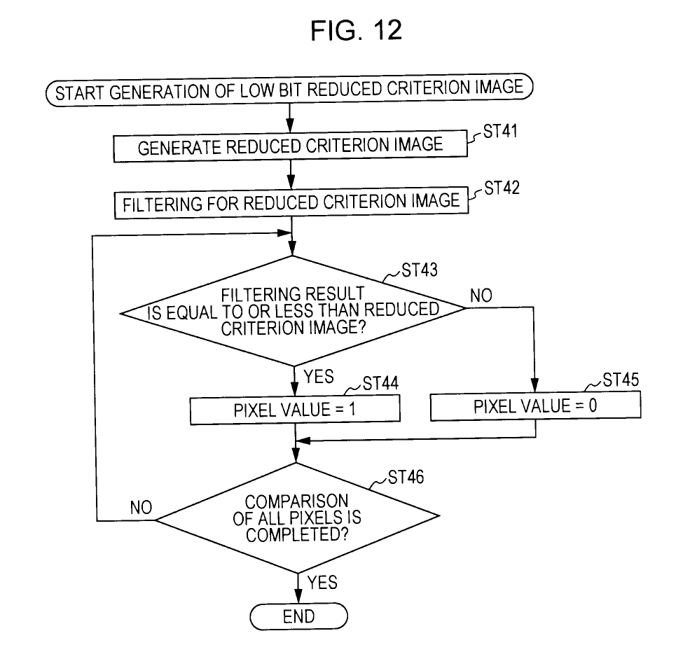

FIG. 12 is a flowchart illustrating a process in the low bit reduced criterion image generation unit 32-c which generates a 1-bit image. At step ST41, the low bit reduced criterion image generation unit 32-c generates a reduced image. The low bit reduced criterion image generation unit 32-c generates a reduced criterion image by generating one pixel from plural pixels in reduction processing unit of the criterion image or by performing pixel subsampling, and the process goes to step ST42.

At step ST42, the low bit reduced criterion image generation unit 32-c performs filtering for the reduced criterion image. The low bit reduced criterion image generation unit 32-c performs the filtering for the image data of the reduced criterion image using a filter such as the mean filter or the band-pass filter, and the process goes to step ST43.

At step ST43, the low bit reduced criterion image generation unit 32-c determines whether or not the filtering result is equal to or less than the reduced criterion image. The low bit reduced criterion image generation unit 32-c makes a comparison between pieces of pixel data in the respective image positions, using the image data after the filtering and the image data of the reduced criterion image. When the pixel data as a result of the filtering is equal to or less than the pixel data of the reduced criterion image, the low bit reduced criterion image generation unit 32-c performs a process at step ST44. On the other hand, when the pixel data as a result of the filtering is greater than the pixel data of the reduced criterion image, the low bit reduced criterion image generation unit 32-c performs a process at step ST45.

The low bit reduced criterion image generation unit 32-c sets a pixel value to “1” at step ST44, and the process goes to step ST46.

The low bit reduced criterion image generation unit 32-c sets a pixel value to “0” at step ST45, and the process goes to step ST46.

At step ST46, the low bit reduced criterion image generation unit 32-c determines whether or not comparison of all pixels is completed. When comparison of all pixels is not completed, the process returns to step ST43, and the low bit reduced criterion image generation unit 32-c compares subsequent pixels. When comparison of all pixels is completed, the low bit reduced criterion image generation unit 32-c finishes the process.

In this way, by comparing the image data before the filtering with the image data after the filtering, it is possible to generate the 1-bit reduced criterion image from the criterion image.

Also, low bit reduced reference image generation units 32-r1 and 32-r2 can generate 1-bit reduced reference images by performing the same process for the reference images as the low bit reduced criterion image generation unit 32-c.

The low bit reduced criterion image generation unit 32-c and the low bit reduced reference image generation units 32-r1 and 32-r2 are not limited to the case where 1-bit images are generated. In other words, in the same manner as the low bit criterion image generation unit 31-c, plural threshold values may be set and then n-bit images may be generated.

By this process, the image data of a criterion image or a reference image can be converted into image data of an n-bit reduced image.

### 1-5. Configuration and Operation of Block Matching Unit

Next, the block matching unit will be described. The block matching unit calculates an evaluated value between a block of a criterion image (a reduced criterion image) and a block of a reference image (a reduced reference image). In addition, the block matching unit detects a motion vector from positions of a block of a criterion image (a reduced criterion image) having the minimal evaluated value and a block of a reference image (a reduced reference image).

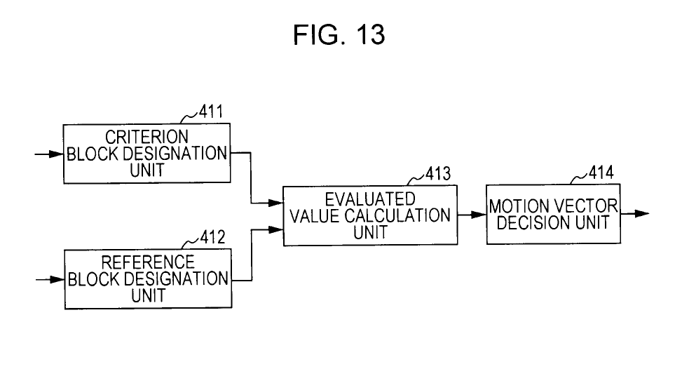

FIG. 13 shows a configuration of the block matching unit 41. The block matching unit 41 performs coarse detection of a motion vector using the low bit reduced criterion image and a first low bit reduced reference image. Also, the block matching unit 43 is configured in the same manner as the block matching unit 41. The block matching unit 43 performs fine detection of a motion vector using the low bit criterion image and the low bit reference image.

A criterion block designation unit 411 designates a block for detecting a motion vector with respect to the low bit reduced criterion image, and outputs image data in the designated block to an evaluated value calculation unit 413.

A reference block designation unit 412 designates a range of a reference block with respect to the search range for a motion vector, and outputs image data in the designated range to the evaluated value calculation unit 413. Here, when the coarse detection of a motion vector is performed, the reference block designation unit 412 outputs image data in the search range after designating all the low bit reduced reference images as the search range, to the evaluated value calculation unit 413.

The evaluated value calculation unit 413 calculates an evaluated value between the block designated by the criterion block designation unit 411 and the block in the search range designated by the reference block designation unit 412. The calculation of the evaluated value is performed for each position by sequentially moving a block in the search range within the search range. The evaluated value calculation unit 413 uses the sum of absolute difference SAD or the sum of XOR SOX as the evaluated valued.

The evaluated value calculation unit 413 performs calculation in Equation 5 when using the sum of absolute difference SAD as the evaluated value. Here, in Equation 5, T(i, j) indicates image data at a position (i, j) in a block of a reduced criterion image, and S(i, j) indicates image data at a position (i, j) in a block of a reduced reference image.

$$SAD = {\sum }_{i} {\sum }_{j} \vert T ( i , j ) - S ( i , j ) \vert \qquad ( 5 )$$

The evaluated value calculation unit 413 performs calculation in Equations 6 and 7 when using the sum of XOR SOX as the evaluated value. Here, in Equation 7 for obtaining an XOR value, T(i, j) indicates image data at a position (i, j) in a block of a reduced criterion image, and S(i, j) indicates image data at a position (i, j) in a block of a reduced reference image.

$$\begin{matrix}SOX = {\sum }_{i} {\sum }_{j} XOR ( i , j ) & ( 6 ) \\ XOR = T ( i , j ) ⊗ S ( i , j ) & ( 7 )\end{matrix}$$

Also, the evaluated value calculation unit 413 performs calculation in Equation 8 for calculation of XOR values of n bits in a case where the bit number of the image data of the reduced criterion image and the reduced reference image is n bits when using the sum of XOR SOX as an evaluated value. That is to say, the calculation in Equation 8 gives “XOR=0” to a case where image data is equal, and gives “XOR=1” to a case where image data is not equal. Also, in Equation 8, “k” indicates a k-th order of a bit number allocated to a pixel.

$$XOR = T ( i , j ) ⊗ S ( i , j ) = {{⋃}_{k = 1}}^{n} ( {T}_{k} ( i , j ) ⊗ {S}_{k} ( i , j ) ) \qquad ( 8 )$$

A motion vector decision unit 414 detects a position of a block of the reduced reference image having the minimal evaluated value with respect to a block of the reduced criterion image. Also, the motion vector decision unit 414 obtains a motion vector from a coordinate difference between the block of the reduced criterion image and the block of the reduced reference image having the minimal evaluated value. Further, the motion vector decision unit 414 outputs the motion vector based on the minimal evaluated value and the position of the block of the reduced reference image when the evaluated value is calculated, to the block matching unit 43 as a motion vector as a result of the coarse detection.

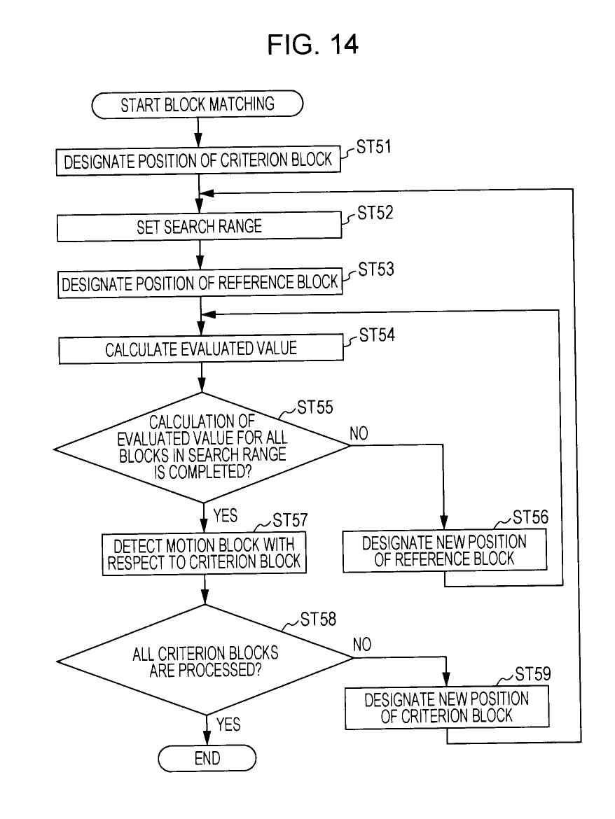

FIG. 14 is a flowchart illustrating a process in the block matching unit 41. At step ST51, the block matching unit 41 designates a position of a criterion block. The block matching unit 41 designates a position of the criterion block for detection of a motion vector with respect to the low bit reduced criterion image, and the process goes to step ST52.

At step ST52, the block matching unit 41 sets a search range. The block matching unit 41 sets the search range for the low bit reduced reference image, and the process goes to step ST53.

At step ST53, the block matching unit 41 designates a position of a reference block. The block matching unit 41 designates a position of the reference block for detection of a motion vector in the search range, and the process goes to step ST54.

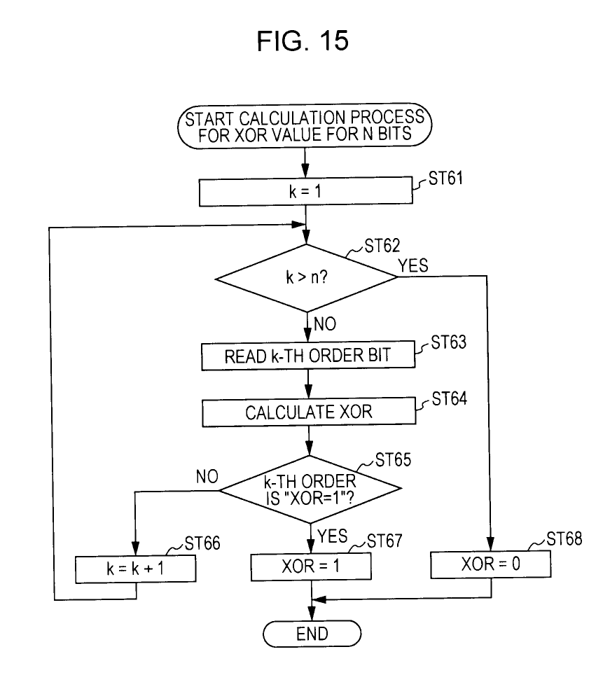

At step ST54, the block matching unit 41 calculates an evaluated value. The block matching unit 41 calculates the evaluated value from pixel data of the criterion block and the reference block. The block matching unit 41 calculates sum of absolute difference SAD or sum of XOR SOX as the evaluated value. When a bit number of the low bit reduced criterion image and the low bit reduced reference image is n bits, the block matching unit 41 calculates an XOR value shown in FIG. 15 and determines an XOR value for each pixel in the block.

At step ST61, the block matching unit 41 sets a parameter k indicating a bit position to “k=1.” The block matching unit 41 sets the parameter k indicating a bit position to “k=1” indicating the least significant bit of pixel data of the low bit reduced criterion image and the low bit reduced reference image, and the process goes to step ST62.

At step ST62, the block matching unit 41 determines whether or not the parameter k is equal to or more than n. When the parameter k is not greater than the most significant bit of the pixel data of the low bit reduced criterion image and the low bit reduced reference image, the block matching unit 41 performs a process at step ST63. On the other hand, when the parameter k is greater than the most significant bit of the pixel data of the low bit reduced criterion image and the low bit reduced reference image, the block matching unit 41 performs a process at step ST68.

At step ST63, the block matching unit 41 reads a k-th order bit. The block matching unit 41 reads the k-th order bit from the pixel data of the low bit reduced criterion image and the low bit reduced reference image, and the process goes to step ST64.

At step ST64, the block matching unit 41 performs an XOR calculation. The block matching unit 41 performs the XOR calculation for data of the k-th order bit read at step ST63, and the process goes to step ST65.

At step ST65, the block matching unit 41 determines whether or not the k-th order is “XOR=1.” When the XOR for the k-th order bit operated at step ST64 is “0,” the block matching unit 41 performs a process at step ST66. When the XOR for the k-th order bit operated at step ST64 is “1,” the block matching unit 41 performs a process at step ST67.

At step ST66, the block matching unit 41 operates “k=k+1” so as to update the parameter k, and the process returns to step ST62.

At step ST67, the block matching unit 41 sets “XOR=1” as the XOR value for n bits, and finishes the process.

At step ST68, the block matching unit 41 sets “XOR=0” as the XOR value for n bits, and finishes the process.

By this process, it is determined whether or not in the pixel data of the low bit reduced criterion image and the low bit reduced reference image, the respective bit values are the same from the least significant bit to the most significant bit. Here, when bit values are not the same, the XOR value becomes “XOR=1.” When all the bit values are the same, the XOR value becomes “XOR=0.” In other words, when the n-bit pixel data of the low bit reduced criterion image and the low bit reduced reference image are not the same, the XOR value for n bits becomes “XOR=1,” and when the n-bit pixel data is the same, the XOR value for n bits becomes “XOR=0.”

In this way, even when a bit number of the image data of the low bit reduced criterion image and the low bit reduced reference image is n bits, it is possible to obtain the XOR value.

Referring to FIG. 14 again, at step ST55, the block matching unit 41 determines whether or not calculation of the evaluated values for all the blocks in the search range is completed. When the calculation of the evaluated values for all the blocks is not completed, the block matching unit 41 performs a process at step ST56, and when the calculation of the evaluated values for all the blocks is completed, the block matching unit 41 performs a process at step ST57.

At step ST56, the block matching unit 41 designates a new position of the reference block. The block matching unit 41 designates a new position of the reference block for which an evaluated value is not calculated in the reference range, and the process returns to step ST54.

At step ST57, the block matching unit 41 detects a motion block for the criterion block. The block matching unit 41 detects the minimal evaluated value from the calculated evaluated values, and detects a motion vector from a coordinate difference between a position of a block of the reduced reference image when the evaluated value is calculated and a position of a block of the reduced criterion image, and the process goes to step ST58.

At step ST58, the block matching unit 41 determines whether or not all the criterion blocks are processed. When the criterion blocks which are not processed remain, the block matching unit 41 performs a process at step ST59, and when the all the criterion blocks are processed, the block matching unit 41 finishes the block matching process.

At step ST59, the block matching unit 41 designates a new position of the criterion block. The block matching unit 41 designates a new position of the criterion block for which a motion vector is not detected, and the process returns to step ST52.

By this process, it is possible to detect a motion vector for each criterion block in the low bit reduced criterion image.

The block matching unit 43 is supplied with the motion vector detected by the coarse detection in the block matching unit 41. Therefore, a reference block range designation unit of the block matching unit 43 sets a search range using as a criterion a position where the criterion block is moved according to the motion vector detected by performing the coarse detection for blocks of the low bit criterion image. The block matching unit 43 performs the block matching process for criterion blocks of the low bit criterion image in the set search range and the reference blocks of the low bit reference image in the search range, and performs the fine detection of a motion vector.

### 1-6. Example of Detection Operation of Motion Vector

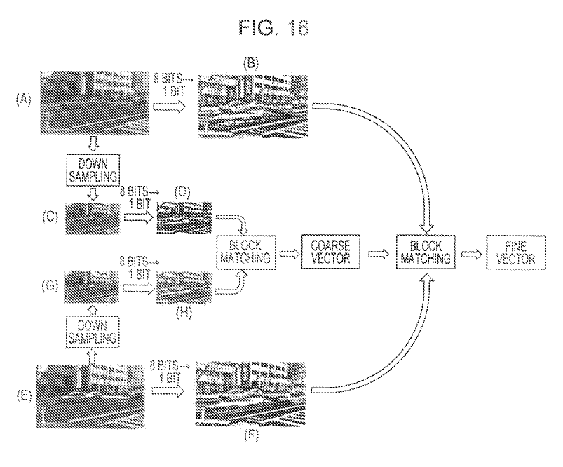

FIG. 16 shows an example of a detection operation of a motion vector using the criterion image and the reference image. An 8-bit criterion image shown in A of FIG. 16 undergoes the bit number reduction process in the low bit criterion image generation unit 31-c and becomes a low bit criterion image of 1-bit shown in B of FIG. 16. Also, the criterion image undergoes the pixel number reduction process in the low bit reduced criterion image generation unit 32-c and becomes a reduced criterion image shown in C of FIG. 16. Further, the reduced criterion image undergoes the bit number reduction process in the low bit reduced criterion image generation unit 32-c and becomes a low bit reduced criterion image of 1 bit shown in D of FIG. 16.

An 8-bit reference image shown in E of FIG. 16 undergoes the bit number reduction process in the low bit reference image generation unit 31-r and becomes a 1-bit low bit reference image shown in F of FIG. 16. Also, the reference image undergoes the pixel number reduction process in the low bit reduced reference image generation unit 32-r and becomes a reduced reference image shown in G of FIG. 16. Further, the reduced reference image undergoes the bit number reduction process in the low bit reduced reference image generation unit 32-r and becomes a low bit reduced reference image of 1 bit shown in H of FIG. 16.

Here, in a case where the reduction process of the bit number allocated to a pixel and the pixel number reduction process are performed together, when there are plural hierarchies where the bit number allocated to a pixel is the same, the information processing device 10 ranks the hierarchies where the bit number is the same, according to the number of pixels. In addition, the information processing device 10 performs the coarse detection of a motion vector using an image having a small number of pixels, and performs the fine detection of a motion vector using an image having a large number of pixels. That is to say, the block matching unit 41 performs the coarse detection of a motion vector using the low bit reduced criterion image which is an image in a hierarchy where the bit number allocated to a pixel is the smallest and the low bit reduced reference image. Further, the block matching unit 43 performs the fine detection of a motion vector using the low bit criterion image and the low bit reference image. The block matching unit 43 decides a search range using the motion vector detected by the coarse detection in the block matching unit 41 as a criterion.

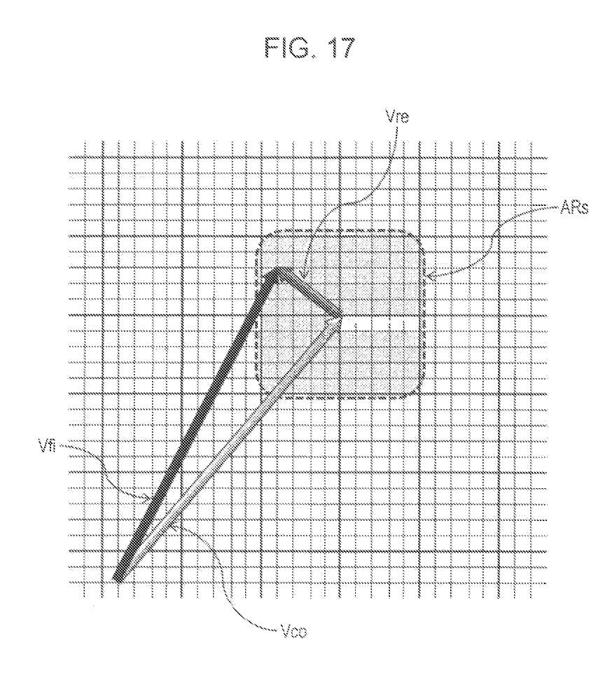

When the process in the above-described first embodiment is performed, since the low bit reduced image is used in the coarse detection of a motion vector, it is possible to decrease the scale of a logic circuit for calculation used for the coarse detection of a motion vector. Further, it is possible to perform the coarse detection of a motion vector with a smaller capacity of a memory. The fine detection of a motion vector uses a bit number equal to or more than in the coarse detection and may use an image of which a reduction ratio is smaller than in the coarse detection or may use an image which is not reduced. In the fine detection of a motion vector, as shown in FIG. 17, a search range ARs is set using a motion vector Vco detected by the coarse detection as a criterion. The fine detection of a motion vector is performed using an image in the search range ARs for the reference image which has a bit number equal to or more than in the coarse detection and of which a reduction ratio is smaller than in the coarse detection or which is not reduced, and a motion vector Vfi is detected. A vector Vre is a vector which leads the motion vector Vco detected by the coarse detection to the motion vector Vfi which is the result of the fine detection, through slight adjustment.

In this way, since the search range ARs is set using the motion vector Vco detected by the coarse detection as a criterion, even when the reference image of which a reduction ratio is smaller than in the coarse detection or which is not reduced is used, it is possible to decrease the scale of the logic circuit for calculation. Further, it is possible to perform the fine detection of a motion vector with a smaller capacity of a memory. It is possible to shorten a calculation time taken to detect a motion vector. Since in the fine detection of a motion vector, the motion vector is detected using an image which has a bit number equal to or more than in the coarse detection, of which a reduction ratio is smaller than in the coarse detection or which is not reduced, it is possible to heighten detection accuracy of a motion vector.

### 2. Second Embodiment

Next, in the second embodiment, a case where a motion vector is detected using two reference images differing in time with respect to a criterion image will be described. Also, in the same manner as the first embodiment, in the second embodiment, a case is shown in which a motion vector is detected using a criterion image and a reference image in two hierarchies where a bit number allocated to a pixel is different. A case is shown in which the pixel number reduction process is performed only for a criterion image and a reference image used in the coarse detection of a motion vector to decrease resolutions of the criterion image and the reference image.

### 2-1. Configuration of Information Processing Device

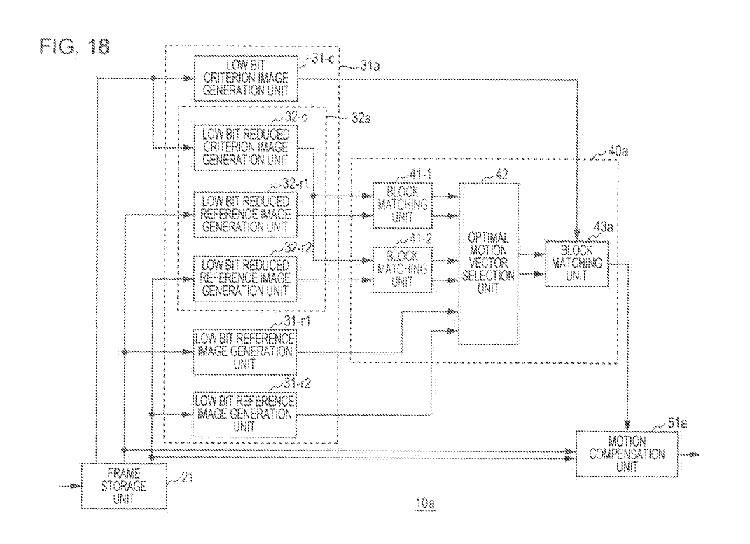

FIG. 18 shows a configuration of a information processing device according to the second embodiment. Also, in the information processing device 10a, the same reference numerals are given to constituent elements corresponding to those of the information processing device 10 shown in FIG. 1.

The information processing device 10a includes an image storage unit 21 which stores input image data. Also, the information processing device 10a includes a bit conversion unit 31a which reduces a bit number allocated to a pixel and which has a low bit criterion image generation unit 31-c, low bit reference image generation units 31-r1 and 31-r2, a low bit reduced criterion image generation unit 32-c, and low bit reduced reference image generation unit 32-r1 and 32-r2. The low bit reduced criterion image generation unit 32-c and the low bit reduced reference image generation units 32-r1 and 32-r2 constitute a resolution conversion unit 32a which generates a reduced image of which a resolution is lowered due to the pixel number reduction process. Further, the information processing device 10a has a motion vector detection unit 40a which detects a motion vector and which has block matching units 41-1, 41-2 and 43 and an optimal motion vector selection unit 42. Further, the information processing device 10a has a motion compensation unit 51a which performs motion compensation using the detected motion vector.

Image data input to the information processing device 10a is supplied to the image storage unit 21. The image storage unit 21 stores image data of a criterion image and two reference images. The image storage unit 21 outputs the stored image data of the criterion image to the low bit criterion image generation unit 31-c and the low bit reduced criterion image generation unit 32-c. The image storage unit 21 outputs the stored image data of the first reference image to the low bit reference image generation unit 31-r1 and the low bit reduced reference image generation unit 32-r1. The image storage unit 21 outputs the stored image data of the second reference image to the low bit reference image generation unit 31-r2 and the low bit reduced reference image generation unit 32-r2.

The low bit criterion image generation unit 31-c performs a bit number reduction process for the image data of the criterion image to generate image data of a low bit criterion image. Also, the low bit criterion image generation unit 31-c outputs the generated image data of the low bit criterion image to the block matching unit 43a. For example, the low bit criterion image generation unit 31-c performs the bit number reduction process for 8-bit image data of a criterion image and outputs image data of a low bit criterion image of which a bit number is 1 bit, to the block matching unit 43a.

The low bit reduced criterion image generation unit 32-c performs the bit number reduction process and the pixel number reduction process for the image data of the criterion image to generate a low bit reduced criterion image. The low bit reduced criterion image generation unit 32-c outputs image data of the generated low bit reduced criterion image to the block matching units 41-1 and 41-2. For example, the low bit reduced criterion image generation unit 32-c performs the bit number reduction process and the pixel number reduction process for 8-bit image data of a criterion image and outputs image data of a low bit reduced criterion image of which the bit number is 1 bit and the pixel number is reduced in horizontal and vertical directions to the block matching units 41-1 and 41-2.

The low bit reference image generation unit 31-r1 performs the bit number reduction process for the image data of the first reference image to generate a first low bit reference image having the same bit number as the low bit criterion image. Also, the low bit reference image generation unit 31-r1 outputs image data of the generated first low bit reference image to the optimal motion vector selection unit 42.

The low bit reduced reference image generation unit 32-r1 performs the bit number reduction process and the pixel number reduction process for the image data of the first reference image to generate a first low bit reduced reference image having the same bit number and pixel number as the low bit reduced criterion image. Also, the low bit reduced reference image generation unit 32-r2 outputs image data of the generated first low bit reduced reference image to the block matching unit 41-1.

The low bit reference image generation unit 31-r2 performs the bit number reduction process for the image data of the second reference image to generate a second low bit reference image having the same bit number as the low bit criterion image. Also, the low bit reference image generation unit 31-r2 outputs image data of the generated second low bit reference image to the optimal motion vector selection unit 42.

The low bit reduced reference image generation unit 32-r2 performs the bit number reduction process and the pixel number reduction process for the image data of the second reference image to generate a second low bit reduced reference image having the same bit number and pixel number as the low bit reduced criterion image. Also, the low bit reduced reference image generation unit 32-r2 outputs image data of the generated second low bit reduced reference image to the block matching unit 41-2.

The block matching unit 41-1 performs the block matching process using the image data of the low bit reduced criterion image output from the low bit reduced criterion image generation unit 32-c and the image data of the first low bit reduced reference image output from the low bit reduced reference image generation unit 32-r1. The block matching unit 41-1 detects a block for which an evaluated value calculated by a block matching process is minimal, and detects a motion vector from positions of two blocks. In addition, the block matching unit 41-1 outputs the detected motion vector and an evaluated value corresponding to the motion vector (the minimal evaluated value) to the optimal motion vector selection unit 42.

The block matching unit 41-2 performs the block matching process using the image data of the low bit reduced criterion image output from the low bit reduced criterion image generation unit 32-c and the image data of the second low bit reduced reference image output from the low bit reduced reference image generation unit 32-r2. The block matching unit 41-2 detects a block for which an evaluated value calculated by a block matching process is minimal, and detects a motion vector from positions of two blocks. In addition, the block matching unit 41-2 outputs the detected motion vector and an evaluated value corresponding to the motion vector (the minimal evaluated value) to the optimal motion vector selection unit 42.

The optimal motion vector selection unit 42 compares the evaluated value output from the block matching unit 41-1 with the evaluated value output from the block matching unit 41-2, and selects a motion vector having a smaller evaluated value which is output to the block matching unit 43a. Also, the optimal motion vector selection unit 42 selects a low bit reference image corresponding to the low bit reduced reference image used in the detection of the selected motion vector, and outputs the selected low bit reference image to the block matching unit 43a. For example, when the evaluated value output from the block matching unit 41-1 is smaller than the evaluated value output from the block matching unit 41-2, the optimal motion vector selection unit 42 outputs the motion vector output from the block matching unit 41-1 to the block matching unit 43a. The selected motion vector is detected from the low bit reduced criterion image and the first low bit reduced reference image. Thus, the optimal motion vector selection unit 42 selects the image data of the first low bit reference image so as to be output to the block matching unit 43a.

The block matching unit 43a detects a motion vector using the image data of the low bit criterion image output from the low bit criterion image generation unit 31-c and the image data of the low bit reference image selected by the optimal motion vector selection unit 42. Here, the block matching unit 43a has been supplied with the motion vector detected using the low bit reduced images, from the optimal motion vector selection unit 42. Therefore, the block matching unit 43a decides a search range using the motion vector supplied from the optimal motion vector selection unit 42 as a criterion, detects a block having a minimal evaluated value in the search range, and detects a motion vector from positions of two blocks. The block matching unit 43a outputs the detected motion vector to the motion compensation unit 51a. The block matching unit 43a outputs reference image identifying information enabling the reference image used to detect the motion vector to be identified, to the motion compensation unit 51a. Further, the reference image identifying information may be output from the optimal motion vector selection unit 42 to the motion compensation unit 51a. The optimal motion vector selection unit 42 may extract an image in the search range from the reference image based on the motion vector, and output a reference image in the search range to the block matching unit 43a.

The motion compensation unit 51a performs motion compensation of the first reference image or the second reference image according to the motion vector detected by the block matching unit 43a, and outputs the motion compensated image. The motion compensation unit 51a may determine the reference image used to detect the motion vector is the first reference image or the second reference image based on the reference image identifying information, and perform the motion compensation using the selected reference image and the motion vector.

### 2-2. Processing Operation of Information Processing Device

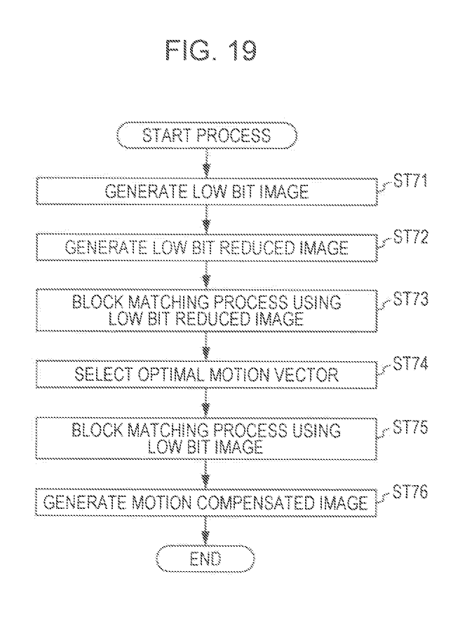

FIG. 19 is a flowchart illustrating a process in the information processing device 10a. At step ST71, the low bit criterion image generation unit 31-c and the low bit reference image generation units 31-r1 and 31-r2 generate low bit images. The low bit criterion image generation unit 31-c performs the bit number reduction process for image data of a criterion image to generate image data of a low bit criterion image. The low bit reference image generation unit 31-r1 performs the bit number reduction process for image data of a first reference image to generate image data of a low bit reference image. The low bit reference image generation unit 31-r2 performs the bit number reduction process for image data of a second reference image to generate image data of a low bit reference image. In this way, the low bit criterion image generation unit 31-c and the low bit reference image generation units 31-r1 and 31-r2 generate the low bit images, and the process goes to step ST72.

At step ST72, the low bit reduced criterion image generation unit 32-c, the low bit reduced reference image generation units 32-r1 and 32-r2 generate low bit reduced images. The low bit reduced criterion image generation unit 32-c performs the bit number reduction process and the pixel number reduction process for the image data of the criterion image to generate image data of a low bit reduced criterion image. The low bit reduced reference image generation unit 32-r1 performs the pixel number reduction process and the bit number reduction process for the image data of the first reference image to generate image data of a first low bit reduced reference image. The low bit reduced reference image generation unit 32-r2 performs the bit number reduction process and the pixel number reduction process for the image data of the second reference image to generate image data of a second low bit reduced reference image. In this way, the low bit reduced criterion image generation unit 32-c, and the low bit reduced reference image generation unit 32-r1 and 32-r2 generate the low bit reduced images, and the process goes to step ST73.

At step ST73, the block matching units 41-1 and 41-2 perform the block matching process using the low bit reduced images. The block matching unit 41-1 performs the block matching process using the image data of the low bit reduced criterion image and the image data of the first low bit reduced reference image and detects a motion vector. The block matching unit 41-2 performs the block matching process using the image data of the low bit reduced criterion image and the image data of the second low bit reduced reference image and detects a motion vector. In this way, the block matching units 41-1 and 41-2 perform coarse detection of a motion vector through the block matching process using the low bit reduced images, and the process goes to step ST74.

At step ST74, the optimal motion vector selection unit 42 selects an optimal motion vector. The optimal motion vector selection unit 42 selects an optimal motion vector, that is, a motion vector having a lower evaluated value, from the motion vectors detected using the two low bit reduced reference images at step ST53, and the process goes to step ST75.

At step ST75, the block matching unit 43a performs the block matching process using the low bit images. The optimal motion vector selection unit 42 performs the block matching process using the image data of the low bit criterion image and image data of the low bit reference image corresponding to the low bit reduced reference image used in the coarse detection of the motion vector selected at step ST74, and performs the fine detection of a motion vector. In this way, the block matching unit 43a performs the fine detection of a motion vector through the block matching process using the low bit images, and the process goes to step ST76.

At step ST76, the motion compensation unit 51a generates a motion compensated image. The motion compensation unit 51a performs the motion compensation for the reference image according to the motion vector detected at step ST75 to generate the motion compensated image, and finishes the process.

### 2-3. Configuration and Operation of Optimal Motion Vector Selection Unit

The low bit reference image generation unit 31-r1 performs the same process for a first reference image as the low bit criterion image generation unit 31-c, and generates a first low bit reference image. The low bit reference image generation unit 31-r2 performs the same process for a second reference image as the low bit criterion image generation unit 31-c, and generates a second low bit reference image.

The low bit reduced reference image generation unit 32-r1 performs the same process for the first reference image as the low bit reduced criterion image generation unit 32-c, and generates a first low bit reduced reference image. The low bit reduced reference image generation unit 32-r2 performs the same process for the second reference image as the low bit reduced criterion image generation unit 32-c, and generates a second low bit reduced reference image.

The block matching unit 41-1 performs the coarse detection of a motion vector using the low bit reduced criterion image and the first low bit reduced reference image in the same manner as the block matching unit 41. The block matching unit 41-2 performs the coarse detection of a motion vector using the low bit reduced criterion image and the second low bit reduced reference image in the same manner as the block matching unit 41. The block matching unit 43a performs of the fine detection of a motion vector using the low bit criterion image and the first low bit reference image or the second low bit reference image in the same manner as the block matching unit 43.

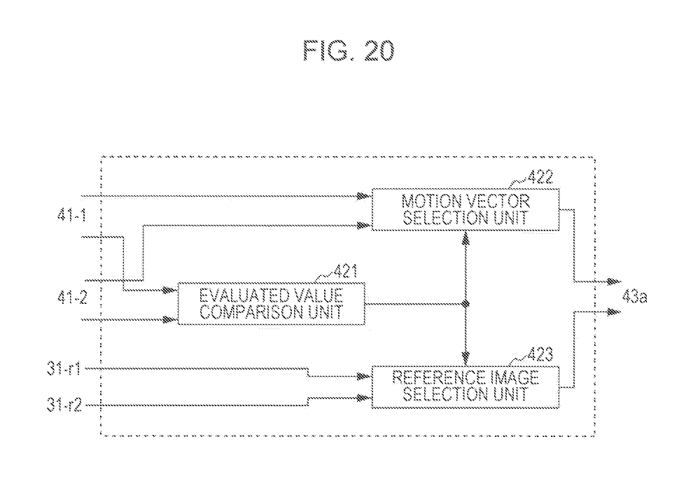

Next, the optimal motion vector selection unit 42 included in the information processing device 10a will be described. FIG. 20 shows a configuration of the optimal motion vector selection unit 42. The optimal motion vector selection unit 42 has an evaluated value comparison unit 421 and a motion vector selection unit 422.

The evaluated value comparison unit 421 compares the evaluated value output from the block matching unit 41-1 with the evaluated value output from the block matching unit 41-2, and outputs the comparison result to the motion vector selection unit 422.

The motion vector selection unit 422 selects a motion vector having a smaller evaluated value based on the comparison result from the evaluated value comparison unit 421, and outputs the selected motion vector to the block matching unit 43a. For example, when the evaluated value output from the block matching unit 41-1 is smaller than the evaluated value output from the block matching unit 41-2, the motion vector selection unit 422 selects the motion vector output from the block matching unit 41-1, and outputs the selected motion vector to the block matching unit 43a. Also, the motion vector selection unit 422 selects any one of the motion vectors having the same evaluated value and outputs the selected motion vector to the block matching unit 43a. The motion vector selection unit 422 generates reference image identifying information indicating that the output motion vector is detected based on which reference image (the minimal evaluated value is calculated based on which reference image), and outputs the information to the block matching unit 43a.

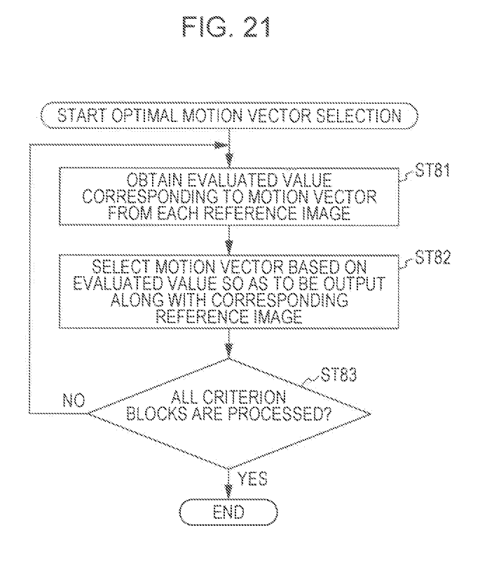

FIG. 21 is a flowchart illustrating a process in the optimal motion vector selection unit 42. At step ST81, the optimal motion vector selection unit 42 obtains evaluated values corresponding to motion vectors from the respective reference images. The optimal motion vector selection unit 42 obtains an evaluated value corresponding to a motion vector detected by the block matching unit 41-1 using the first low bit reduced reference image. The optimal motion vector selection unit 42 obtains an evaluated value corresponding to a motion vector detected by the block matching unit 41-2 using the second low bit reduced reference image, and the process goes to step ST82.

At step ST82, the optimal motion vector selection unit 42 selects a motion vector based on the evaluated values, and outputs the selected motion vector along with the reference images. The optimal motion vector selection unit 42 makes a comparison between the evaluated values obtained at step ST81, and selects a motion vector having a minimal evaluated value for output. The optimal motion vector selection unit 42 determines a reference image used to detect the selected motion vector, and outputs the low bit reference image of the determined reference image, and the process goes to step ST83.

At step ST83, the optimal motion vector selection unit 42 determines whether or not all the criterion blocks are processed. When blocks which are not processed remain, the optimal motion vector selection unit 42 designates a block which is not processed, and the process returns to step ST81. The optimal motion vector selection unit 42 finishes selection of an optimal motion vector when all the criterion blocks are processed.

### 2-4. Example of Detection Operation of Motion Vector

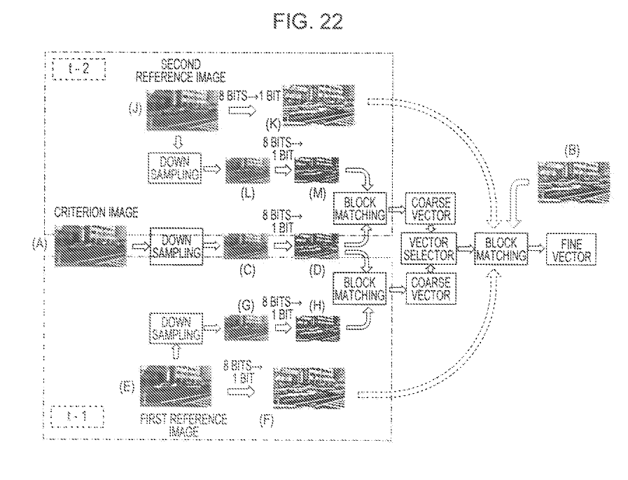

FIG. 22 shows an example of a detection operation of a motion vector using a criterion image and two reference images. A criterion image shown in A of FIG. 22 undergoes the bit number reduction process in the low bit criterion image generation unit 31-c and becomes a low bit criterion image shown in B of FIG. 22. Also, the criterion image undergoes the pixel number reduction process in the low bit reduced criterion image generation unit 32-c and becomes a reduced criterion image shown in C of FIG. 22. Further, the reduced criterion image undergoes the bit number reduction process in the low bit reduced criterion image generation unit 32-c and becomes a low bit reduced criterion image shown in D of FIG. 22.

As shown in E of FIG. 22, for example, a first reference image prior to one frame undergoes the bit number reduction process in the low bit reference image generation unit 31-r1 and becomes a first low bit reference image shown in F of FIG. 22. Also, the first reference image undergoes the pixel number reduction process in the low bit reduced reference image generation unit 32-r1 and becomes a first reduced reference image shown in G of FIG. 22. Further, the first reduced reference image undergoes the bit number reduction process in the low bit reduced reference image generation unit 32-r1 and becomes a first low bit reduced reference image shown in H of FIG. 22.

As shown in J of FIG. 22, for example, a second reference image prior to two frames undergoes the bit number reduction process in the low bit reference image generation unit 31-r2 and becomes a second low bit reference image shown in K of FIG. 22. Also, the second reference image undergoes the pixel number reduction process in the low bit reduced reference image generation unit 32-r2 and becomes a second reduced reference image shown in L of FIG. 22. Further, the second reduced reference image undergoes the bit number reduction process in the low bit reduced reference image generation unit 32-r2 and becomes a second low bit reduced reference image shown in M of FIG. 22.

Here, in a case where the reduction process of the bit number allocated to a pixel and the pixel number reduction process are performed together, when there are plural hierarchies where the bit number allocated to a pixel is the same, the information processing device 10a ranks the hierarchies where the bit number is the same, according to the number of pixels. In addition, the information processing device 10a performs the coarse detection of a motion vector using an image having a small number of pixels, and performs the fine detection of a motion vector using an image having a large number of pixels.

That is to say, the block matching unit 41-1 performs the coarse detection of a motion vector using the low bit reduced criterion image, shown in D of FIG. 22, which is an image in a hierarchy where the bit number allocated to a pixel is the smallest and the first low bit reduced reference image shown in H of FIG. 22. The block matching unit 41-2 performs the coarse detection of a motion vector using the low bit reduced criterion image, shown in D of FIG. 22, which is an image in a hierarchy where the bit number allocated to a pixel is the smallest and the second low bit reduced reference image shown in M of FIG. 22.

The optimal motion vector selection unit 42 compared the evaluated value output from the block matching unit 41-1 with the evaluated value output from the block matching unit 41-2, and selects a motion vector having a smaller evaluated value so as to be output to the block matching unit 43a. Also, the optimal motion vector selection unit 42 selects a low bit reference image corresponding to the low bit reduced reference image used to detect the selected motion vector and outputs the selected low bit reference image to the block matching unit 43a. For example, the optimal motion vector selection unit 42 selects the motion vector from the block matching unit 41-1 so as to be output to the block matching unit 43a and simultaneously selects image data of the first low bit reference image shown in F of FIG. 22 so as to be output to the block matching unit 43a.

The block matching unit 43a performs the fine detection of a motion vector using the low bit criterion image shown in B of FIG. 22 and the low bit reference image, selected by the optimal motion vector selection unit 42, shown in F of FIG. 22 or shown in K of FIG. 22. The block matching unit 43a decides a search range using the motion vector selected by the optimal motion vector selection unit 42 as a criterion.

When the process in the above-described second embodiment is performed, in the same manner as the first embodiment, since the low bit reduced image is used in the coarse detection of a motion vector, it is possible to decrease the scale of a logic circuit for calculation used for the coarse detection of a motion vector. Further, it is possible to perform the coarse detection of a motion vector with a smaller capacity of a memory. The fine detection of a motion vector uses a bit number more than in the coarse detection and may use an image of which a reduction ratio is smaller than in the coarse detection or may use an image which is not reduced. In the fine detection of a motion vector, since a search range is set using a motion vector detected by the coarse detection, even when an image of which a reduction ratio is smaller than in the coarse detection or which is not reduced is used, it is possible to decrease the scale of the logic circuit for calculation. Further, it is possible to perform the fine detection of a motion vector with a smaller capacity of a memory and further to shorten a calculation time taken to detect a motion vector. Since in the fine detection of a motion vector, the motion vector is detected using an image which has a bit number equal to or more than in the coarse detection, of which a reduction ratio is smaller than in the coarse detection or which is not reduced, it is possible to heighten detection accuracy of a motion vector.

In the second embodiment, since plural reference images are used, when taken images are interlaced scanning type images, it is possible to finely detect a motion vector by using a reference image of the same field. In addition, when a portion of an image is hidden by a moving object, since the hidden portion of the image can be easily obtained by using plural reference images, it is possible to finely detect a motion vector.

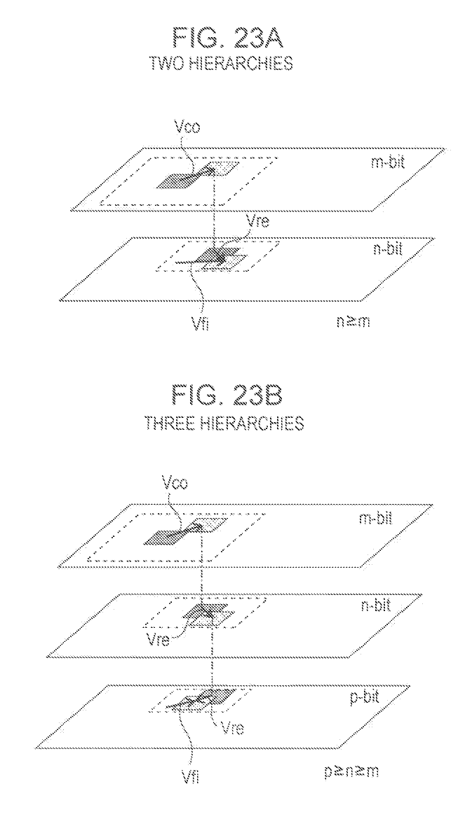

In the first and second embodiments, although the coarse detection of a motion vector is performed using the image in the first hierarchy and the fine detection of a motion vector is performed using the image in the second hierarchy, the hierarchies are not limited to two hierarchies shown in FIG. 23A. For example, as shown in FIG. 23B, the number of hierarchies is three or more, and the information processing device performs the coarse detection of a motion vector using an image of which a bit number allocated to a pixel is smallest, and, based on the detected motion vector, sets a search range for detection of a motion vector in the next hierarchy. Also, the information processing device performs the same process for the other hierarchies and designates a motion vector detected using an image of which a bit number allocated to a pixel is largest as a motion vector with highest accuracy. In this way, the information processing device can detect a motion vector with high accuracy by detecting a motion vector using the hierarchy.

In addition, in a case where the reduction process of the bit number allocated to a pixel and the pixel number reduction process are performed together, when there are plural hierarchies where the bit number allocated to a pixel is the same, the information processing device ranks the hierarchies where the bit number is the same, according to the number of pixels. In addition, the information processing device performs the coarse detection of a motion vector using an image having a small number of pixels (an image having a lower resolution), and performs the fine detection of a motion vector using an image having a large number of pixels (an image having a higher resolution). In this way, when the hierarchies are ranked, even if there are plural hierarchies where a bit number allocated to a pixel is the same, it is possible to easily detect a motion vector with high accuracy. In FIGS. 23A and 23B, a motion vector Vco is detected by the coarse detection of a motion vector. A motion vector Vfi is detected by the fine detection of a motion vector. A vector Vre is a vector which leads the motion vector Vco detected by the coarse detection to the motion vector Vfi which is the result of the fine detection, through slight adjustment.

Also, in the first and second embodiments, although the block matching process is performed using an image in the search range from the reference image having undergone the bit number reduction process, the bit number reduction process or the pixel number reduction process may be performed only for the image in the search range. In this case, in the same manner as the first and second embodiments, it is possible to detect a motion vector with high accuracy. Also, it is possible to decrease a range of images which undergo the bit number reduction process or the pixel number reduction process.

### 3. As to the Case Where the Process is Performed Using Program

The above-described series of processes may be performed by hardware or software. When a series of processes is performed by the software, a computer is employed in which programs constituting the software are embedded in dedicated hardware. In addition, for example, the software is installed from a program recording medium to a general personal computer which can execute various kinds of functions by installing various kinds of programs.

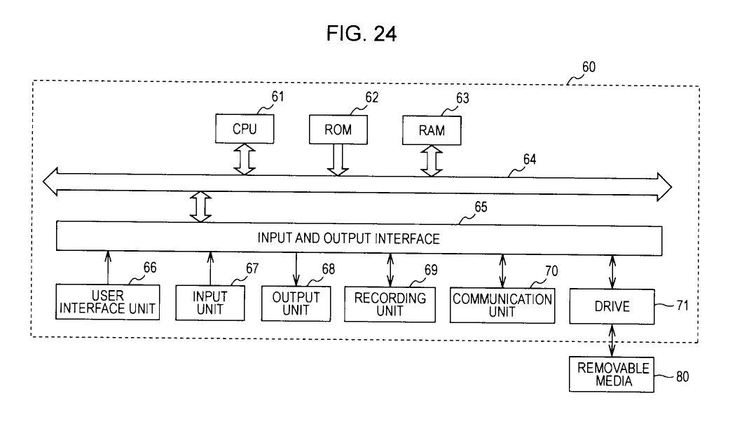

FIG. 24 is a diagram illustrating a configuration example of hardware of a computer which performs the above-described series of processes using a program.

In the computer 60, a CPU (central processing unit) 61, a ROM (read only memory) 62, and a RAM (random access memory) 63 are connected to each other via a bus 64.

The bus 64 is also connected to an input and output interface 65. The input and output interface 65 is connected to a user interface unit 66 constituted by a keyboard, a mouse, or the like, an input unit 67 for inputting image data, an output unit 68 constituted by a display or the like, and a recording unit 69 constituted by a hard disc or a nonvolatile memory, or the like. Also, the input and output interface 65 is connected to a communication unit 70 constituted by a network interface or the like, and a drive 71 which drives a removable medium 80 such as a magnetic disk, an optical disc, a magnetic optical disc, or a semiconductor memory.

In the computer configured as described above, for example, the CPU 61 loads a program recorded in the recording unit 69 to the RAM 63 via the input and output interface 65 and the bus 64 and executes the program, thereby performing the above-described series of processes.

The program executed by the computer (the CPU 61) is recorded in the removable medium 80 which is a package medium constituted by a magnetic disk (including a flexible disc), an optical disc (including a CD-ROM (compact disc-read only memory) and DVD (digital versatile disc)), a magnetic optical disc, or a semiconductor memory or the like, or is provided using wired or wireless transmission medium such as a local area network, the Internet, or digital satellite broadcasting.

The program may be installed in the recording unit 69 through the input and output interface 65 by installing the removable medium 80 in the drive 71. Also, the program may be received by the communication unit 70 via the wired or wireless transmission medium, and may be installed in the recording unit 69. Alternately, the program may be installed in the ROM 62 or the recording unit 69 in advance.

The program executed by the computer may be a program where processes are performed in a time series according to the order described in this specification, or may be a program executed in parallel therewith or a program where processes are performed at a necessary timing such as when accessed.

The present application contains subject matter related to that disclosed in Japanese Priority Patent Application JP 2010-024041 filed in the Japan Patent Office on Feb. 5, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device comprising:
a bit conversion unit that performs reduction in a bit number allocated to a pixel for a criterion image and a reference image and generates a criterion image and a reference image which are hierarchized according to a bit number allocated to a pixel; and
a motion vector detection unit that performs a block matching process using a criterion image and a reference image and detects a motion vector from a block position in which a difference between blocks is minimal,
wherein the motion vector detection unit performs coarse detection of a motion vector by block matching using the criterion image and the reference image of which a bit number is reduced, decides a search range for fine detection of a motion vector based on the motion vector detected by the coarse detection, and performs fine detection of a motion vector using an image in the search range which belongs to a hierarchy equal to or more than an image used in the coarse detection in a bit number allocated to a pixel.

2. The information processing device according to claim 1, further comprising a resolution conversion unit that performs downsampling for the criterion image and the reference image to reduce resolutions of the criterion image and the reference image,
wherein the motion vector detection unit performs coarse detection of a motion vector by block matching using the criterion image and the reference image of which a resolution is reduced, decides a search range for fine detection of a motion vector based on the motion vector detected by the coarse detection, and performs fine detection of a motion vector using an image in a fine search range equal to or more than an image used in the coarse detection in a resolution.

3. The information processing device according to claim 2, wherein the motion vector detection unit performs a block matching process using a criterion image and a reference image in a hierarchy where a bit number allocated to a pixel is smallest, and performs coarse detection of a motion vector.

4. The information processing device according to claim 2, wherein the motion vector detection unit uses an image having a higher resolution than an image used in the coarse detection as an image in the search range, when using an image in the search range having the same bit number allocated to a pixel as the image used in the coarse detection.

5. The information processing device according to claim 1, wherein the reference image is a plurality of images different from the criterion image in time.

6. The information processing device according to claim 1, wherein the bit conversion unit performs filtering for the criterion image and the reference image, makes a comparison between pixel levels before and after the filtering for each pixel, and generates a criterion image and a reference image of which a bit number is reduced based on a result of the comparison.

7. The information processing device according to claim 6, wherein the bit conversion unit performs a level shift process where the pixel level after the filtering is shifted by a predetermined amount, compares the pixel level after the filtering with the pixel level after the level shift process every pixel, and generates a criterion image and a reference image of which a bit number is reduced based on a result of the comparison.

8. The information processing device according to claim 6, wherein the bit conversion unit performs the filtering using a mean filter or a band-pass filter.

9. The information processing device according to claim 1, wherein the criterion image and the reference image are 8-bit images in a bit number allocated to a pixel, and
wherein the bit conversion unit performs reduction in a bit number for the criterion image and the reference image to generate a criterion image and a reference image of which a bit number allocated to a pixel is 1 bit.

10. An information processing method comprising the steps of:
causing a bit conversion unit to perform reduction in a bit number allocated to a pixel for a criterion image and a reference image and generate a criterion image and a reference image which are hierarchized according to a bit number allocated to a pixel; and
causing a motion vector detection unit to perform coarse detection of a motion vector by block matching using the criterion image and the reference image of which a bit number is reduced, decide a search range for fine detection of a motion vector based on the motion vector detected by the coarse detection, and perform fine detection of a motion vector using an image in the search range which belongs to a hierarchy equal to or more than an image used in the coarse detection in a bit number allocated to a pixel.

11. A program enabling a computer to perform the steps of:
performing reduction in a bit number allocated to a pixel for a criterion image and a reference image and generating a criterion image and a reference image which are hierarchized according to a bit number allocated to a pixel; and
performing coarse detection of a motion vector by block matching using the criterion image and the reference image of which a bit number is reduced, deciding a search range for fine detection of a motion vector based on the motion vector detected by the coarse detection, and performing fine detection of a motion vector using an image in the search range which belongs to a hierarchy equal to or more than an image used in the coarse detection in a bit number allocated to a pixel.
